(19) United States
(12) Patent Application Publication
(10) Pub. No.: US 2017/0286992 A1
(43) Pub. Date: Oct. 5, 2017

(54) SYSTEM AND METHOD FOR CODED TRANSACTION PROCESSING

(71) Applicant: The Grocer Exchange, LLC., Canton, MA (US)

(72) Inventors: Robert H. Lounsbury, JR., Evanston, IL (US); Frank Edward Romero, Canton, MA (US)

(21) Appl. No.: 15/627,322

(22) Filed: Jun. 19, 2017

Related U.S. Application Data
(63) Continuation-in-part of application No. 14/106,063, filed on Dec. 13, 2013.
(60) Provisional application No. 62/351,566, filed on Jun. 17, 2016.

(51) Int. Cl. G06Q 30/02

(52) U.S. Cl. CPC G06Q 30/0238; G06Q 20/3223

(57) ABSTRACT

An coupon distribution and processing platform system allows its members/constituents to receive services associated with the purchase of consumer products. Specifically, a user, registered with the system, accesses an account and electronically selects one or more coupons to be associated with a card device. Thereafter, when the user's card device is scanned at a particular retail entity, the accounts associated with the user and retail entity are credited, while the account associated with the manufacturer is debited. Further, the user, the manufacturer, and the retail entity, each having a corresponding account, may select one or more services provided by with the system website.

This application claims priority to U.S. Provisional Application 62/351,566 filed Jun. 17, 2016, and also is a continuation-in-part application of U.S. application Ser. No. 14/106,063 filed on Dec. 13, 2013, the entire contents of the above applications being incorporated herein by reference.

### BACKGROUND OF THE INVENTION

### Field of the Invention

The present invention is directed to distributing and processing coupons, and more particular to a system and method for coupon distribution and processing.

### Background Information

Traditional paper coupons are typically issued by manufacturers and purveyors of consumer packaged goods to consumers for the purposes of granting discounts or rebates as a purchase incentive. Paper coupons suffer many deficiencies that include, inter alia, a high cost for coupon distribution and handling, imprecise delivery of the coupons to the desired shopper, inconvenience to the shopper, potential fraud, reconciliation delay, slow and imprecise tracking, and limited audit control, etc. Further, with traditional paper coupons, shoppers typically receive their savings by either being charged less at the point of sale (i.e., at the register), or receiving the savings as cash/coins at the register of a retailer. The retailer must bear the financial burden of the cash discount or rebate until such time as they are compensated through a coupon settlement process. The retailer is adversely affected by the typically long delay in clearinghouse settlement and essentially carries the face value float of the redeemed coupon for an extended period of time. Further, compensation may be denied for some coupons because of expiration, counterfeiting, etc.; the grocer does not learn of the denial until long after the transaction and must bear the financial loss. Finally, product manufacturers and grocery stores do not typically have an easy way to obtain reliable, precise, or accurate statistical information associated with the use of coupon discounts by customers.

### SUMMARY OF THE INVENTION

In an illustrative embodiment, a coupon distribution and processing platform (CDPP) allows its members/constituents to receive services associated with the purchase of consumer products. Specifically, a shopper, registered with the CDPP, accesses an account with the CDPP, via exemplary web page(s), and may electronically select (i.e., “load”) one or more coupons to be associated with a coupon card. The one or more coupons are associated with products manufactured by one or more manufacturers registered with the CDPP, and sold at grocer entities registered with the CDPP. When the shopper's coupon card is scanned at a point of service/sale (POS) node (e.g., cash register) associated with a particular grocer entity, the account associated with the shopper is credited based on a value of the electronic coupon(s). The electronic coupon(s) may have been previously selected by the shopper and associated with the coupon card, or may be automatically provided to the shopper. In an alternative embodiment, the shopper's credit card, associated with a financial services institution, may be scanned at the grocer entity. The financial services institution may provide a unique identifier, associated with the shopper, to the CDPP, so that the CDPP can credit the shopper's account based on the value of the electronic coupon(s).

In an illustrative embodiment, the accumulated savings may be stored in a financial account associated with the shopper and maintained by a particular banking institution for later user. For example, the accumulated savings obtained utilizing the coupon card, membership card, or credit card may be applied towards a minimum payment requirement associated with a credit card of the shopper, or as consumer/family payment events (e.g., back-to-school spending, vacations, etc.). Moreover, and in response to the scanning of the coupon card or membership card at the POS node or the scanning of the credit card, the grocer entity receives a handling fee from the CDPP, also referred to herein as a discount incentive management platform (DIMP) for handling the electronic coupon and/or discount incentive, and the manufacturer is charged/debited a fee by the CDPP or DIMP.

Further, the shopper, the manufacturer, and the grocer entity, each having an account with the CDPP, may select one or more services provided by the CDPP. These services may be selected utilizing one or more graphical user interface (GUI) screens associated with the CDPP. Such services include, but are not limited to, receiving promotions, advertising services, receiving statistical data regarding the sales of products.

Preferred embodiments can utilize a coded payment device to pay for the purchase of goods or services and also to associate with each product or service an identification code that identifies the user. The coded payment device can be a credit card device having a barcode imprinted thereon or a credit card device having an electronic circuit mounted on the card device. The circuit including a memory with stored coded information such that payment with the card can automatically associate scanned or stored discount data associated with the transaction. The electronic circuit can be an integrated circuit chip mounted on a plastic that stores data in a memory including the identification data of the device user, as well as data sufficient to purchase the product or service.

Payment can also be made using a wireless mobile communication device, such as an internet enabled cellular phone, having a near field communication (NFC) circuit that transmits data to the retail register that is configured with an NFC scanner that can transmit and/or receive data to or from the mobile device. The NFC circuit can include a controller and a memory configured to enable transmission of user identification data, and optionally coupons or discount data for the user which can be downloaded onto device memory by the user. The mobile device can include an electronic display operative to display a bar code, QR code or other coded information or data that can be scanned at the POS node scanner. Such mobile devices can include a data processor, memory devices that can store or retrieve discount data or electronic coupons associated with the device user, wherein the device is further configured and encrypted to utilize a credit card of the user to enable payment by the user for products or services.

Preferred embodiments of the system can employ authenticated electronic transactions using a secure hash standard (SHS) wherein a condensed representation of electronic data messages is used to generate a message digest having a defined lengths. A hash computation can be employed using a message schedule, such as eighty 32 bit words, a plurality of working variables having 32 bits each, for example, and a hash value of five 32 bit words. This system can thus employ a standardized computational system for formatting of secure data communications.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is an exemplary network environment in which the principles of the present invention may be implemented;

FIG. 2 is a block diagram of an exemplary coupon distribution and processing platform in accordance with an illustrative embodiment of the present invention;

FIG. 3 is an exemplary screenshot of a web page illustrating a graphical user interface (GUI) screen in accordance with an illustrative embodiment of the present invention;

FIG. 4 is an exemplary screenshot of a web page illustrating a GUI screen after selecting a manufacturer tab in accordance with an illustrative embodiment of the present invention;

FIG. 5 is an exemplary screenshot of a web page illustrating a GUI screen after selecting a grocer tab in accordance with an illustrative embodiment of the present invention;

FIG. 6 is an exemplary flowchart detailing the steps of a procedure for interaction between a manufacturer node and/or a grocer entity node with the CDPP in accordance with an illustrative embodiment of the present invention;

FIG. 7 is an exemplary screenshot of a web page illustrating a GUI screen after selecting a shopper tab in accordance with an illustrative embodiment of the present invention;

FIG. 8 is an exemplary flowchart detailing the steps of a procedure for interaction between a shopper and the CDPP in accordance with an illustrative embodiment of the present invention;

FIGS. 9A and 9B are an exemplary flowchart detailing the steps of a procedure for distributing and processing coupons in accordance with an illustrative embodiment of the present invention;

FIG. 10 is an exemplary flowchart detailing the steps of a procedure for preventing a purchased item from fulfilling the purchase requirements of more than one discount in accordance with various embodiments of the present invention;

FIGS. 11A-11C are partial views of an exemplary flowchart detailing the steps of a procedure for processing discount incentives in accordance with various embodiments of the present invention;

FIG. 12A depicts an exemplary flowchart detailing a process of settling validated discount incentives using one or more financial transfer requests in accordance with various embodiments of the present invention;

FIGS. 12B(a)-12B(e) depict a flowchart of an embodiment for processing checkout of a purchase; and

FIG. 12C illustrates a schematic of a system for coupon processing.

### DETAILED DESCRIPTION

Systems and methods taught herein provide a coupon distribution and processing platform (CDPP) or a discount incentive management platform (DIMP) that allow members/constituents to receive services and benefits associated with the purchase of consumer products.

A manufacturer, registered with the DIMP, can load one or more discount incentive offers into the DIMP (or CDPP) and can specify details for each offer including, but not limited to, promotional messages, the amount of discount offered, the quantities of specific product(s) that must be purchased by the shopper to be eligible to receive the discount, and valid dates of the offer. As used herein, the term “coupon” or “electronic coupon” can include discount incentives or discount incentive offers as described herein.

A shopper, registered with the DIMP, can access an account with the DIMP, via exemplary web page(s) or other means, and may electronically select one or more available discount incentive offers which can then be associated by the DIMP with the shopper's DIMP account.

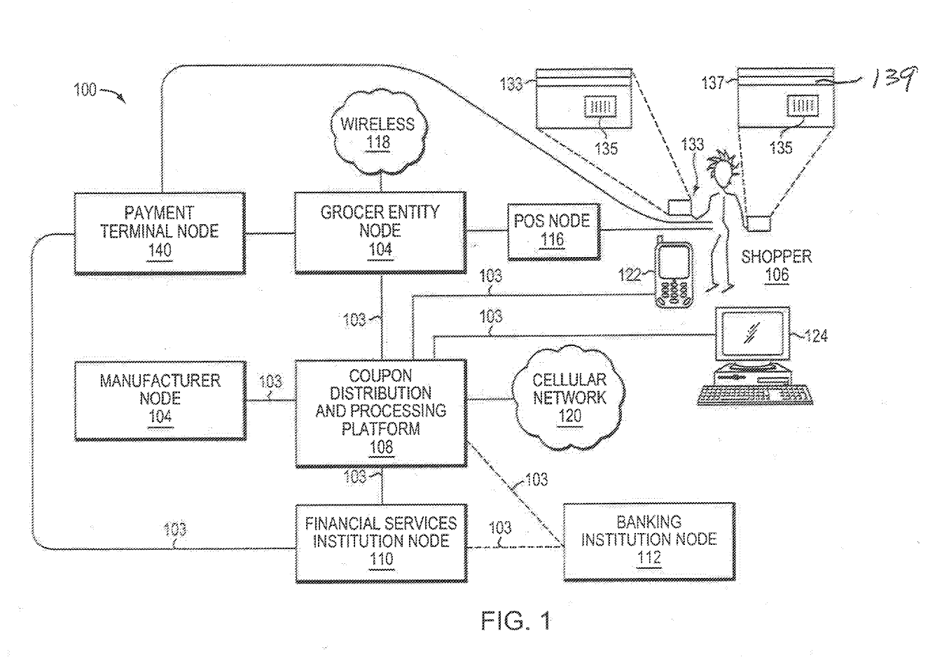

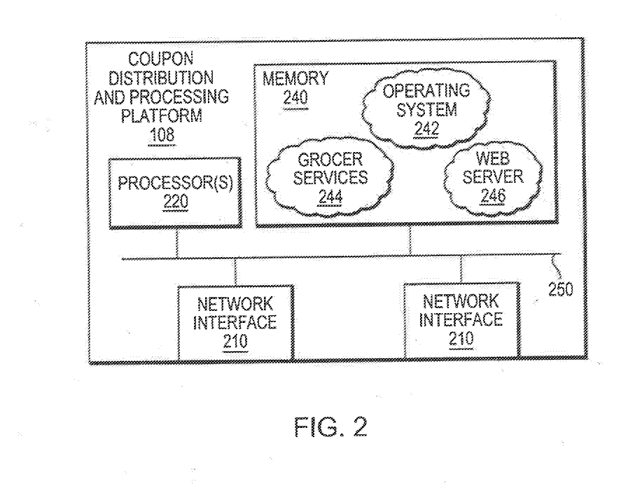

A grocer, registered with the DIMP, can stock and sell items specifically referenced by manufacturer discount incentive offers loaded into the DIMP. The grocer's POS nodes can be equipped with software and/or hardware so as to effect the transmission of checkout transaction data to the DIMP. Embodiments of the management system are illustrated in connection with FIGS. 1, 2 and 12C.

When a shopper completes the selection of items to be purchased during a visit to a grocer entity node, the shopper's discount incentives coded payment card 133, mobile device 107 or membership card 137 can be scanned in some embodiments at a point of service/sale (POS) node 116 (e.g., cash register) associated with a particular grocer entity. The discount incentives membership card can include coded data associated with the shopper. For example, the discount incentives membership card can include a two-dimensional or three-dimensional visual pattern such as a barcode printed onto the card, a microchip 145, a magnetic stripe 139, or any other method of encoding information onto a card known in the art. Data encoded on the card can be captured by the POS node and appended to the current transaction data in the form of, for example, a Global Trade Identification Number (Global Standards One (GS1) Application Identifier 01, abbreviated GTIN and also known as a UPC-A product code) and/or Serial Number (GS1 Application Identifier 21). In an alternative embodiments wherein the shopper pays using a credit or debit card associated with a financial services institution, basic information from the shopper's credit or debit card sufficient to identify and associate the shopper with a particular DIMP account can be captured from the card by the payment terminal node 140 and stored by the POS node 116 within the current transaction data as tender (form of payment) data.

Upon completion of the checkout transaction, the POS node 116 can transmit the transaction data to the DIMP 108 including a user's identification code that enables the system to identify stored discount data for products and/or services, that the user can apply to the transaction. The transaction data can comprise a plurality of data fields including, price amount, discount amount, location or entity code, date, etc.

The DIMP can perform a series of automated processes. In some embodiments, the DIMP can parse the checkout transaction data and identify the associated DIMP shopper account using either the encoded data retrieved from the mobile device or card or the tender data captured by the payment terminal node. In some embodiments, the DIMP can automatically retrieve from storage discount incentive offers previously selected by the shopper and associated with the membership card. In some embodiments, the DIMP can retrieve discount incentives that may be available to the shopper that were not previously selected or offered.

The DIMP can match or validate items actually purchased against the purchases required for eligibility for each of the available discount incentive offers. The DIMP can disallow purchased items for which the shopper or user has already received a benefit by means of redemption of a paper coupon as reported in the transaction data. In some embodiments, the DIMP can allow purchased items to count towards eligibility for only one discount incentive offer unless an alternative is explicitly provided for by the terms or rules of the discount incentive offer. The system (DIMP) can then credit the account of the associated shopper with the value of validated discount incentives, credit the account of the grocer or retail entity with handling fees, credit the account of the DIMP operator with handling fees, and debit the account of the sponsoring manufacturer for the sum value of the credits. The discount incentives thus redeemed can be marked in the customer's DIMP record and can become invalid for future redemption.

In some embodiments, information can be provided to shoppers, grocers, and manufacturers through web pages. The information can be updated automatically and instantly once DIMP processing of a checkout transaction is completed. On completion of processing, the DIMP can send notification to the shopper via email, mobile telephone text message, or other means to inform them of the successful processing of the transaction or to summarize the discount benefits redeemed.

The DIMP can periodically transmit funds transfer requests to the banking institution node 112 to effect transfer of funds between accounts associated with the shopper, grocer, and manufacturer to thereby fully settle all financial obligations.

FIG. 1 is an exemplary network environment 100 in which a manufacturer node 102, a grocer entity node 104 (e.g., retailer) having one or more point of service/sale (POS) nodes 116, a shopper 106, a coupon distribution and processing platform (CDPP) 108, a financial services institution node 110, and a banking institution node 112 are interconnected by communication links 103 of a computer network. This system is described in U.S. application Ser. No. 14/106,063 filed on Dec. 13, 2013, the entire contents of this application being incorporated herein by reference. In some embodiments, the coupon distribution and processing platform 108 can be a discount incentive management platform (DIMP). As known by those skilled in the art, a computer network or data network is a telecommunications network that allows hardware devices (e.g., computers) to exchange data. In computer networks, hardware devices pass data to each other along data connections, such as exemplary communication links 103.

The communication links 103 (network links) between the nodes are established using either cable media or wireless media, as known by those skilled in the art. Further, the CDPP 108 may communicate over cellular network 120 with one or more mobile devices 122. As known by those skilled in the art, the cellular network 120 (i.e., mobile network) is a wireless network distributed over land areas called cells, each served by at least one fixed-location transceiver, known as a cell site or base station. In the cellular network 120, each cell uses a different set of frequencies from neighboring cells, to avoid interference and provide guaranteed bandwidth within each cell. For example, the CDDP 108 may facilitate the sending of messages to mobile devices over the cellular network 120.

Each entity may directly or indirectly communicate with the CDPP 108 over the communication links 103 of the computer network. The manufacturer node or the discount source entity node 102 may be associated with a consumer packaged goods (CPG) company, e.g., a manufacturer of a product that may be purchased by a shopper. For example, the shopper may purchase groceries, electronics, or other products/services.

The retail entity node 104 may be associated with a store or entity that sells products/services to consumers/shoppers, and that utilize the POS nodes 116. The POS node 116 may comprise hardware and/or software loaded thereon to allow the CDDP 108 to perform a variety of functions. Specifically, the loaded hardware and/or software illustratively allows the CDPP 108 to determine whether products purchased by the shopper have an associated electronic coupon, to perform various credits and debits. For example, the loaded hardware and/or software can provide information needed by the CDPP 108 by transmitting the details of each checkout transaction to the CDPP 108. Further, data, compiled at particular POS nodes 116 (e.g., cash register data), may be transmitted over a wireless network 118 or any type of network and received and stored, for example, at the CDPP 108. The financial services institution node 110 may be associated with a financial institution, e.g., a credit card company, that provides financial functions (e.g., credit checks, lines of credit) to its members. Financial services institution node 110 has associated payment terminal nodes 140 that are utilized at the grocer entity node 104.

The banking institution node 112 is an entity associated with a banking institution that provides banking functions (e.g., loan, maintaining banking accounts) to its members. It is noted that financial institutions and banking institutions adhere to particular rules and regulations as set forth by particular governing bodies. For example, banks in a particular state may have to adhere to federal banking laws as well as the banking laws of the particular state. Further, it is noted that the banking institution node 112 may be the same entity as the financial services institution node 110. As such, the description of a separate financial services institution node 110 and a banking institution node 112 should be taken as exemplary only. The banking institution node 112 may be directly connected to the CDPP 108, or may be indirectly connected to the CDPP 108, though, for example, the financial services institution node 110 (as seen by the dotted lines).

Shopper 106 may be a consumer who purchases products or services from particular stores utilizing the novel coupon card 133, payment card, mobile device, or membership card associated with the program that describes the interaction between the various entities and the CDPP 108, as described below. The coupon card 133 may be similar to a credit card, or a different card that has a bar code, or some other sort of unique signature 135 that can identify the user, the users account, the entity issuing the card such that system can process payments using the card as well as process discounts or coupons for a particular transaction as described herein. In alternative embodiments, the coupon card 133 may be a virtual card, for example, that the shopper may have “stored” on its mobile device or configured on a mobile application of the mobile device. Moreover, the shopper has a credit card 137, provided by the financial institution node 110, wherein the credit card has a signature 135. In some embodiments, the credit card 137 can include encoded data that uniquely identifies the shopper 106. The data may be encoded onto the credit card 137 in the form of a two-dimensional or three-dimensional visual pattern printed onto the card, a data processing and electronic memory circuit such as a microchip, a magnetic stripe 139, or any other method of encoding information onto a credit card as known in the art. The credit card 137 may be scanned at the POS 116 when the shopper 106 wishes to purchase a product at grocer entity node 104. In some embodiments, the POS 116 can retrieve the encoded data from the credit card 137. The encoded data can be transmitted to the grocer entity node 104 and can be included in the transaction data transmitted from the POS node 116 to the CDPP 108. In some embodiments, the payment terminal node 140 can retrieve information stored or encoded in or on the credit card 137 including, but not limited to, the shopper's name, last four digits of the card number, the type or brand of card, and the card expiration date. The retrieved information can be transmitted by the payment terminal node 104 to the POS node 116 and grocer entity node 104 and can be included in the transaction data transmitted to the DIMP 108. Further, the shopper 106 may utilize a mobile phone 122 and/or computer 124 to interact with the different entities (e.g., POS node 116, CDPP 108, etc.) in FIG. 1. Those skilled in the art will understand that any number of nodes, devices and/or links may be used in environment 100.

FIG. 2 is an exemplary block diagram of an exemplary CDPP 108 that may be used with one or more embodiments described herein. The CDPP 108 may comprise a plurality of network interfaces 210, one or more processors 220, and a memory 240 interconnected by a system bus 250. The network interfaces 210 contain the mechanical, electrical, and signaling circuitry for communicating data over physical links coupled to the network. The network interfaces may be configured to transmit and/or receive data using a variety of different communication protocols, as known by those skilled in the art.

The memory 240 comprises a plurality of locations that are addressable by the processor(s) 220 and the network interfaces 210 for storing software programs and data structures associated with the embodiments described herein. The processor(s) 220 may comprise necessary elements or logic adapted to execute the software programs and manipulate the data structures. An operating system 242, portions of which are typically resident in memory 240 and executed by the processor(s), functionally organizes the node by, inter alia, invoking network operations in support of software processes and/or services executing on the node. These software processes and/or services may comprise grocer services 244 that facilitate communication between each entity and the CDPP 108. Specifically, grocer services 244 contain computer executable instructions executed by processor(s) 220 to perform functions associated with the distribution, publication, or processing of electronic coupons or discount incentives, and more specifically, for allowing the manufacturer node, grocer node, and shopper to receive services from the CDPP 108, as described below.

The CDPP 108 may further include a web server 246. The web server 246 delivers/serves up web pages to the different entities. For example, the web server 246 of the CDPP 108 may utilize a client/server model and the World Wide Web's Hypertext Transfer Protocol (HTTP) to serve files that form web pages, as described below, to users (e.g., manufacturer node 102, grocer entity node 104, financial services institution node 110, banking institution node 112, and POS node 116).

Further, it will be apparent to those skilled in the art that other types of processors and memory, including various computer-readable media, such as non-transitory computer readable medium, may be used to store and execute program instructions pertaining to the techniques described herein. Also, while the embodiments herein are described in terms of processes or services stored in memory, alternative embodiments also include the processes described herein being embodied as modules consisting of hardware, software, firmware, or combinations thereof. Further, it is noted that the other entities (e.g., manufacturer node 102, grocer entity node 104, financial services institution node 110, banking institution node 112, and POS node 116) illustratively have similar hardware components to that of the CDPP 108.

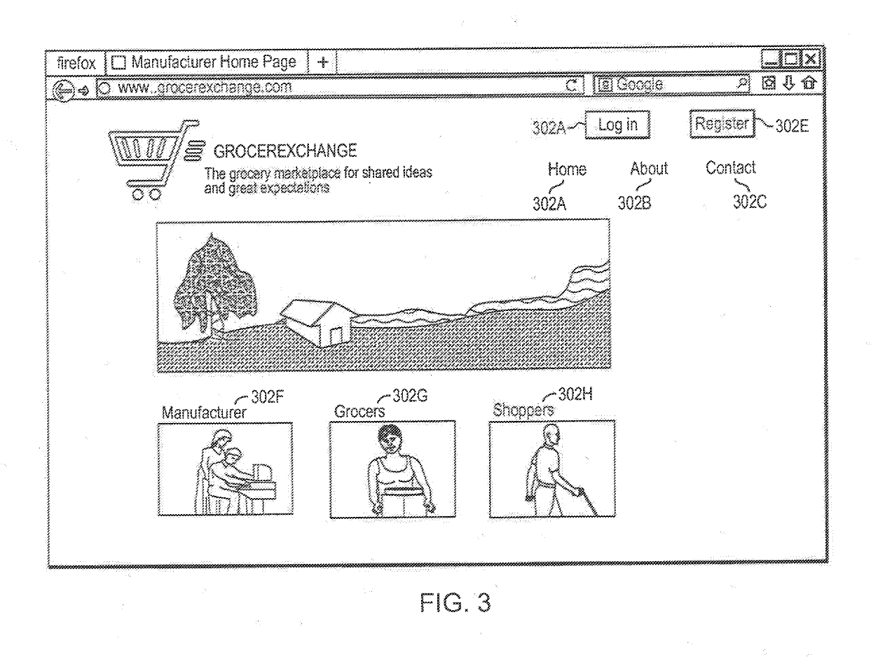

FIG. 3 is an exemplary screenshot of a web page illustrating a home screen 300 in accordance with an illustrative embodiment of the present invention. Specifically, the home screen 300 may be reached by inputting a specific uniform resource locator (URL) or a web address in a web browser, as known by those skilled in the art. The home screen 300 illustratively includes one or more tabs 302 that allow users to interact with the CDPP 108. Specifically, tabs 302 may include, but are not limited to, a home tab 302A, an about tab 302B, a contact tab 302C, a login tab 302D, a register tab 302E, a manufacturer tab 302F, a grocer tab 302G, and a shopper tab 302H.

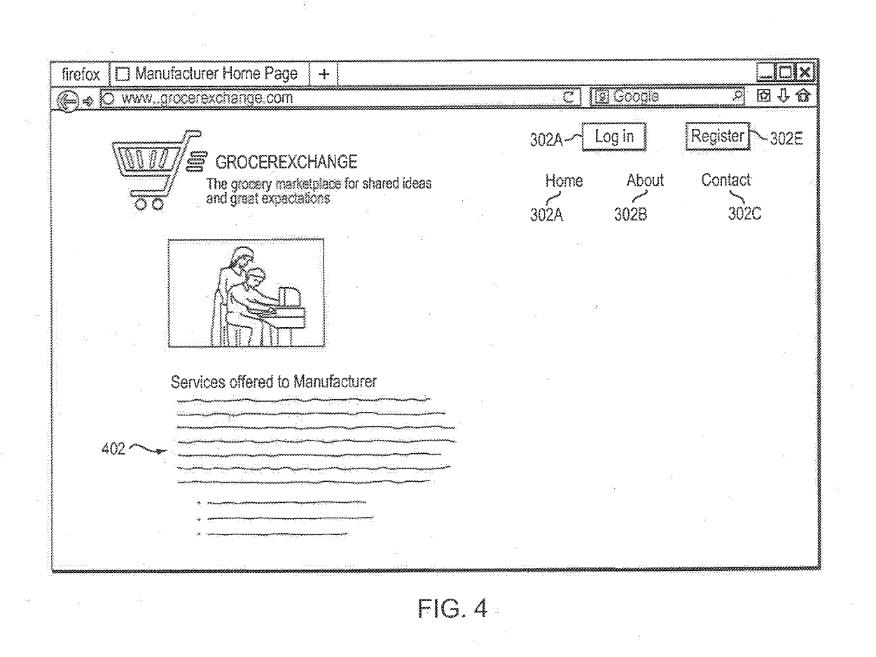

If a user selects a particular tab 302, the user may be brought to a different web page associated with a different URL. The home tab 302A may be selected by a user to bring the user back to home screen 300 at any point in time. For example, when the user selects various tabs and move to different web pages, as shown in FIGS. 4, 5, and 7, the user may select the home tab 302A to come back to the home screen 300. The About tab 302B may be selected by a user to obtain background information regarding the CDPP 108 and the program implemented by the CDPP 108. For example, such information may indicate, but is not limited to, the goal of the CDPP 108, when the program implemented by the CDPP 108 was started, etc. The contact tab 302C may be selected by a user to obtain contact information, such as an email or a phone number, associated with the CDPP 108. For example, the emails or phone number may be associated with individuals who work for the CDPP 108, and can assists users and answer questions the users may have.

The login tab 302D may be selected by a user to login to an account of the CDPP 108, wherein the account is associated with the user or entity that the user may work for or be associated with. For example, a chief financial officer (CFO) or other authorized user acting on behalf of a particular manufacturer or grocer entity may provide a username and password, after selecting the login tab 302D, to gain access to a particular account associated with the CDPP 108. Alternatively, a shopper may provide a username and password, after selecting the login tab 302D, to gain access to his/her account. Specifically, a user may utilize a hardware device, such as a laptop, to input the username and password into one or more graphical user interface (GUI) windows/screens provided by the CDPP 108. If the correct username and password are provided, the user is given access to the account. If the correct username and password are not provided, the user may be provided an error message, as known by those skilled in the art.

If a particular manufacturer, grocer, or shopper does not have an established account, a new account can be created. Specifically, an authorized user acting on behalf of a manufacturer or grocer entity may select register tab 302E and provide particular information to establish the new account. For example, the authorized user may enter address information, bank account information, and other information associated with the manufacturer or grocer entity. It is noted that in most instances, only those authorized individuals have certain proprietary information needed to setup a legitimate account on behalf of the manufacturer and the grocer entity. Further, a shopper may provide particular user information to establish the new account. For example, the shopper may provide personal information, such as name, address, etc., to establish the new account. Once the new account is established and set up, a username and password may be provided so that the manufacturer, grocer entity, and shopper can select login tab 302D to access the particular account. For example, the CDPP 108 may email the username and password to the user.

The manufacturer tab 302F may be selected by a user interested in learning about the services offered to manufacturers by the CDPP 108. Specifically, by selecting manufacturer tab 302F, the user may be brought to a new web page or URL that provides a description of the services provided to a manufacturer by the CDPP 108. FIG. 4 is an exemplary screenshot of a web page illustrating a GUI screen after selecting the manufacturer tab 302F in accordance with an illustrative embodiment of the present invention.

For example, the description 402 may indicate that the CDPP 108 provides advertising and sales promotion channels for manufacturers, and enable manufacturers to directly and effectively deliver marketing communications to shoppers and independent grocer entities in different markets, such as urban markets. For example, the CDPP 108 may advertise for products of the manufacturer at particular grocer entities. Further, the CDPP 108 may capture cash register data that the CDPP 108 then utilizes to create statistical market reports that are provided to the manufacturer. Other analytical information associated with the manufacturer's products may be gathered by the CDPP 108 and provided to the manufacturer.

For example, the manufacturer may receive, from the CDPP 108, information regarding the placement of its products on particular shelves at the grocer entities. The manufacturer may utilize this information to then alter its marketing resources or provide feedback to the CDPP 108, wherein the CDPP 108 may utilize the feedback to change the placement of the manufacturer's products. It is noted that the CDPP 108 can collect and report data in near real time through use of a wireless network 118 or any type of network, such that comprehensive and accurate reports may be available to the manufacturer by accessing its account associated with the CDPP 108. Other services, such as QR bar coding programs, in-store product sampling and demo programs, in-store mobile phone advertisement programs, and in-store mobile phone surveys may be provided to the manufacturer by the CDPP 108. For example, the manufacturer may login and access its account and select one or more services utilizing GUI screens provided by CDPP 108. The grocer services 244 of the CDPP 108 may design and implement the services selected by the manufacturer.

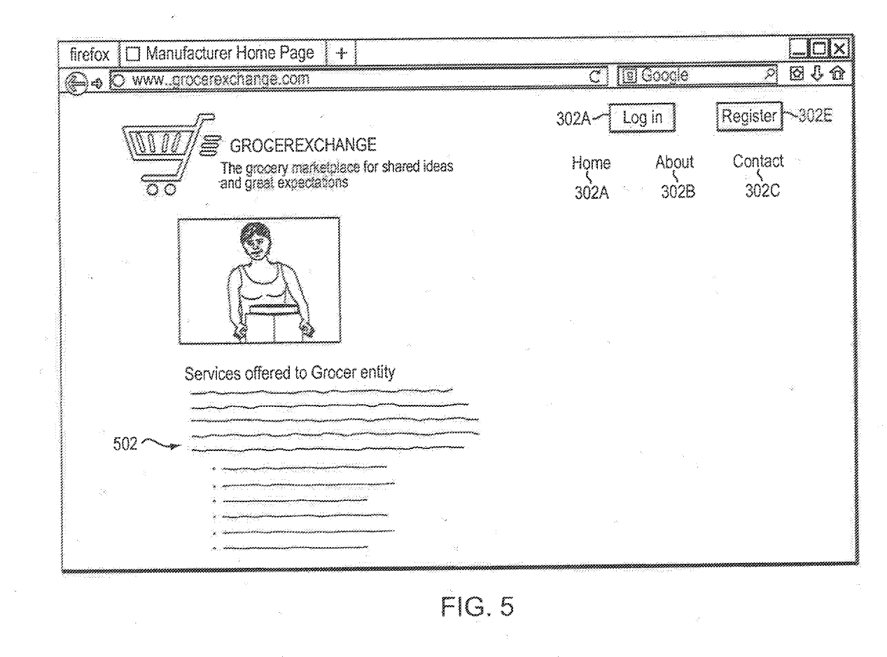

The grocer tab 302G may be selected by a user interested in learning about the services offered to grocer entities by the CDPP 108. Specifically, by selecting the grocer tab 302G, the user may be brought to a new web page or URL that provides a description of the services provided to the grocer entity by the CDPP 108. FIG. 5 is an exemplary screenshot of a web page illustrating a GUI screen after selecting the grocer tab 302G in accordance with an illustrative embodiment of the present invention.

For example, the description 502 may indicate that the CDPP 108 provides advertising, sales promotion channels for grocer entity, and enables grocer entities to directly and effectively deliver marketing communications to shoppers. For example, the CDPP 108 may advertise for the grocer entity on shopping carts, billboards, etc. Further, the CDPP 108 may captures data for the grocer entity that allows the grocer entity to better understand the marketplace and its customers. For example, the CDPP 108 may implement a mobile application to gather survey data and/or feedback from shopper's regarding their experience at the grocer entity. That data may be organized by the CDPP 108, and the grocer entity may login and access the associated account to view the data. Advantageously, the grocer entity may utilize that data to better serve its customers. Other information, data, and services may be provided by the CDPP 108 to the grocer entity, and the description of the CDPP 108 providing data and advertising services to the grocer entity is simply exemplary in nature.

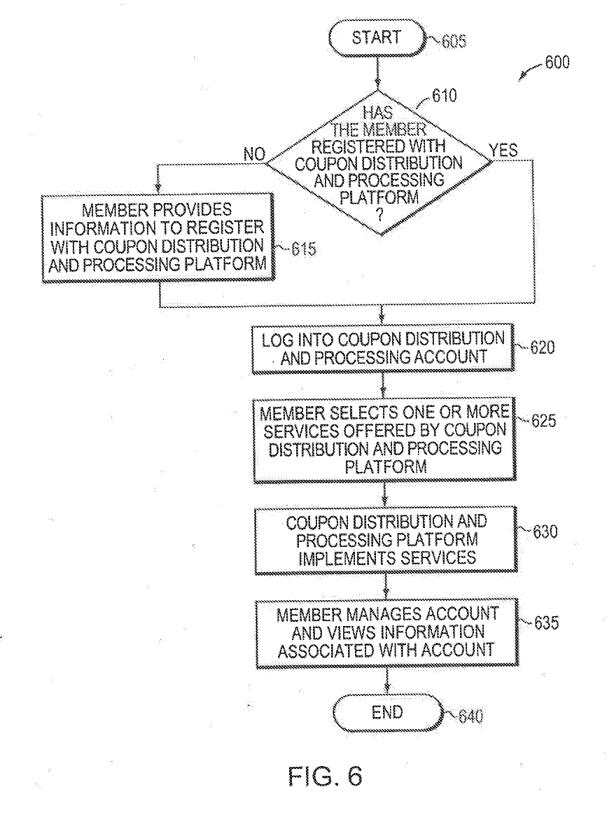

FIG. 6 is an exemplary flowchart detailing the steps of a procedure 600 for interaction between a manufacturer node and/or a grocer entity node with the CDPP in accordance with an illustrative embodiment of the present invention. Specifically, procedure 600 start at step 605 and continues to step 610 wherein it is determined whether a member (e.g., manufacturer or grocer entity) is registered with the CDPP 108 and has a corresponding account. If at step 610 it is determined that the member has registered with the CDPP 108 and has a corresponding account, the procedure branches to step 620. If at step 610 it is determined that the member has not registered with the CDPP 108 and does not have a corresponding account, the procedure branches to step 615 where an authorized user on behalf of the member (e.g., manufacturer or grocer entity) provides pertinent information to register with the CDPP 108 and establish a corresponding account. For example, the authorized user may utilize a personal computer, a laptop, a tablet, or a different hardware device to input such pertinent information into one or more GUI screens provided by the CDPP 108. The authorized user may enter address information, bank account information, and other information associated with the manufacturer or grocer entity into the GUI screens. It is noted that in most instances, only those authorized individual have certain proprietary information needed to setup a legitimate account on behalf of the manufacturer and grocer.

The procedure then continues on to step 620. At step 620, an authorized user on behalf of the member logs into the corresponding account by providing a username and password obtained after registering with the CDPP 108. At step 625, the authorized user may select one or more services offered by the CDPP 108 to the member. For example, the authorized user may request particular statistical data, advertising services, an in-store demo program, and may also provide electronic coupons to the CDPP 108 that may be utilized by the shopper 106, as described in more detail below.

Specifically, the CDPP 108 may install hardware and/or software onto the POS node 116 associated with the grocer entity. Thereafter, and as shoppers purchase products, the data (including checkout transaction data) associated with the POS nodes 116 may be captured and compiled by the hardware and/or software installed on the POS node 116, and transmitted to the CDPP 108 for organization, processing, and storage. The captured data may then be provided to the manufacturer and/or grocer entity, through the manufacture and/or grocer entity accessing their corresponding accounts. At step 630, the CDPP 108 may implement the services selected by the authorized user. At step 635, the authorized user manages the corresponding account and views information associated with the account. For example, the authorized user may manage the manufacturer's or grocer's bank account that may be maintained by a financial services institution node 110/banking institution node 112. At step 640, the procedure ends.

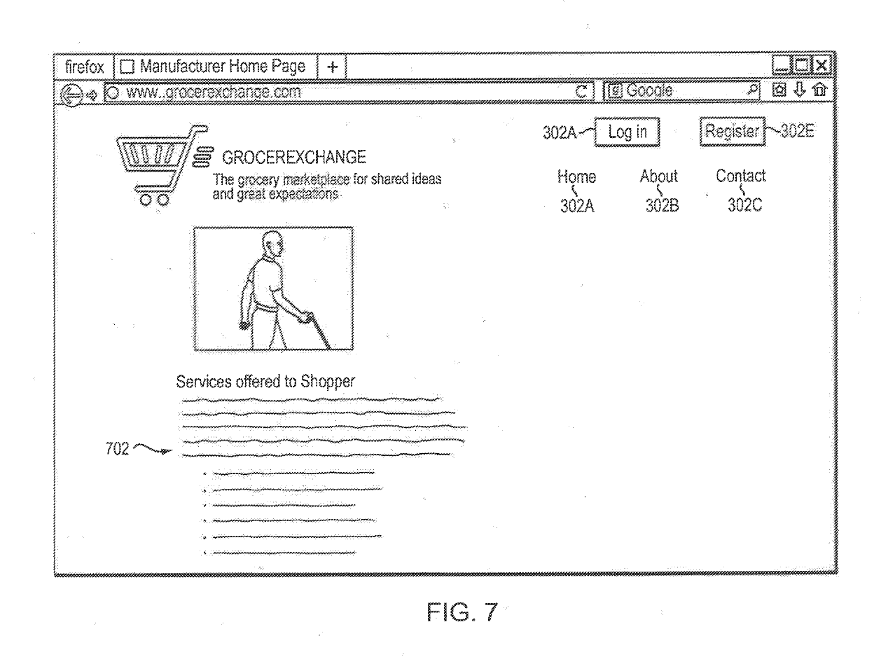

Referring back to FIG. 3, the shopper tab 302H may be selected by a user interested in learning about the services offered to shoppers by the CDPP 108. Specifically, by selecting the shopper tab 302H, the user may be brought to a new web page or URL that provides a description of the services provided to the shopper by the CDPP 108. FIG. 7 is an exemplary screenshot of a web page illustrating a GUI screen after selecting the shopper tab 302G in accordance with an illustrative embodiment of the present invention. The description 702 describes services that may be provided to the shopper 106 that may include, but are not limited to, receiving information about upcoming discounts, promotions, and coupons so that the shopper can plan shopping trips to save money.

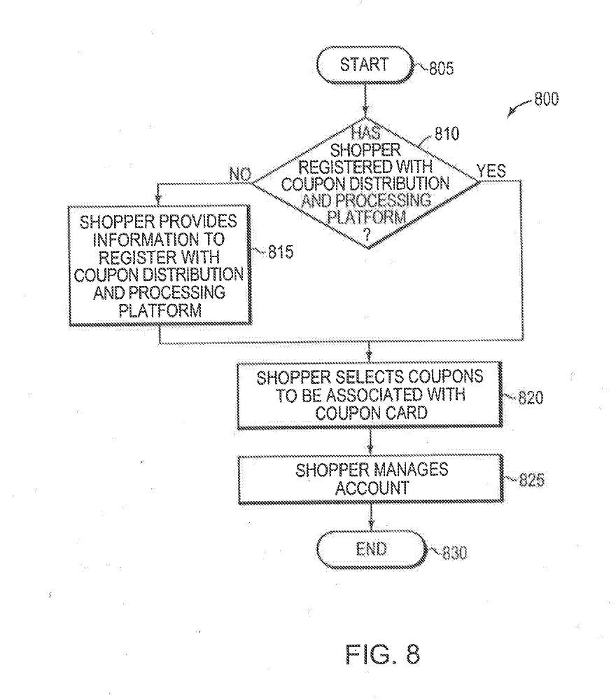

FIG. 8 is an exemplary flowchart detailing the steps of a procedure 800 for interaction between a shopper and the CDPP in accordance with an illustrative embodiment of the present invention. Specifically procedure 800 starts at step 805 and continues to step 810 wherein it is determined whether a shopper is registered with the CDPP 108 and has a corresponding account. If, at step 810, it is determined that the shopper has registered with the CDPP 108 and has a corresponding account, the procedure branches to step 820. If at step 810 it is determined that the shopper has not registered with the CDPP 108 and does not have a corresponding account, the procedure branches to step 815 where a shopper provides pertinent personal information to register with the CDPP 108 and establishes a corresponding account. For example, the shopper may utilize a personal computer, a laptop, a tablet, or a different hardware device to input such personal information (e.g., name, social security number, address, etc.) into one or more GUI screens provided by the CDPP 108. After registering, the shopper may receive a username and password via email and a coupon card 133 via mail, for example. In some embodiments, a financial services institution may issue and mail a credit or debit card 137 to the shopper after performing certain actions, such as a credit check, etc. Alternatively the financial services institution can enable a wireless mobile device payment protocol such that a user can pay for goods and services using the NFC enabled wireless mobile communication device at a retail node that is operative to actuate the coupon processing system as described herein. NFC circuits, controllers, tags and scanners are available from NXP Semiconductor, Austin, Tex. The procedure then continues on to step 820.

At step 820, the shopper electronically selects one or more coupons associated with one or more products of interest, to be associated with the shopper's card, payment device or CDPP account. For example, the shopper may first login to his/her corresponding account utilizing a username and password. The shopper may then electronically select coupons associated with products the shopper wishes to purchase at the grocer entity (registered with the CDPP 108), wherein the product are associated with a manufacturer (registered with the CDPP 108). More specifically, the shopper may navigate one or more web pages associated with the CDPP 108 and select (i.e., “load”) electronic coupons that the shopper wishes to utilize at the grocer entity. Thereafter, when the shopper 106 has the coupon card 133 scanned at the POS node 116 or credit card 137 scanned at payment terminal node 104, the CDPP 108 can determine, based on identification information associated with the shopper 106, if the products purchased at the grocer entity are associated with electronic coupons that were previously selected by the shopper 106 utilizing the web pages associated with the CDPP 108. If the products are associated with coupons previously selected by the shopper 106, the CDPP 108 credits the shopper's account, as explained below.

In alternative embodiments, the shopper 106 may not be required to select the electronic coupons via the web pages associated with the CDPP. Instead, the CDPP 108 may credit the shopper's account simply based on the fact that the shopper 106 purchased the product at the grocer entity. Advantageously, the manufacturer can automatically provide particular coupons to shoppers without requiring the shopper to select the coupons prior to checkout. It is further noted that the shopper 106 may qualify for particular coupons based on certain criteria. For example, a manufacturer may indicate that an electronic coupon should be provided to a shopper if the shopper purchases a certain number of products or if the shopper has been provided certain advertisements, etc. As such, the description of a shopper selecting particular coupons, or the shopper automatically being provided particular coupons without selection, are to be taken as exemplary only.

At step 825, the shopper manages his/her account. For example, the shopper may utilize one or more GUI screens provided by the CDPP 108 to indicate the manner in which the accumulated savings, obtained utilizing the coupon card 133, should be applied. The shopper may put the accumulated savings towards a minimum payment requirement of a credit card that the shopper is currently utilizes. For example, the credit card may be associated with the financial institution through which the user obtained the coupon card 133. In alternative embodiments, the accumulated savings may be stored in a financial account associated with the shopper, where the financial account may be maintained by a particular banking institution. For example, the CDPP 108 may apply the shopper's accumulated savings to the minimum payment requirement for the credit card, and then deposit the remaining savings in the shopper's bank account. Alternatively, the remaining savings may be applied to the remaining balance of the credit card, or paid out in any manner selected by the shopper. Further, the shopper may indicate that the saving should be aggregated by the CDPP 108, and then applied in the selected manner periodically (e.g., at the end of the month). At step 830, the procedure ends.

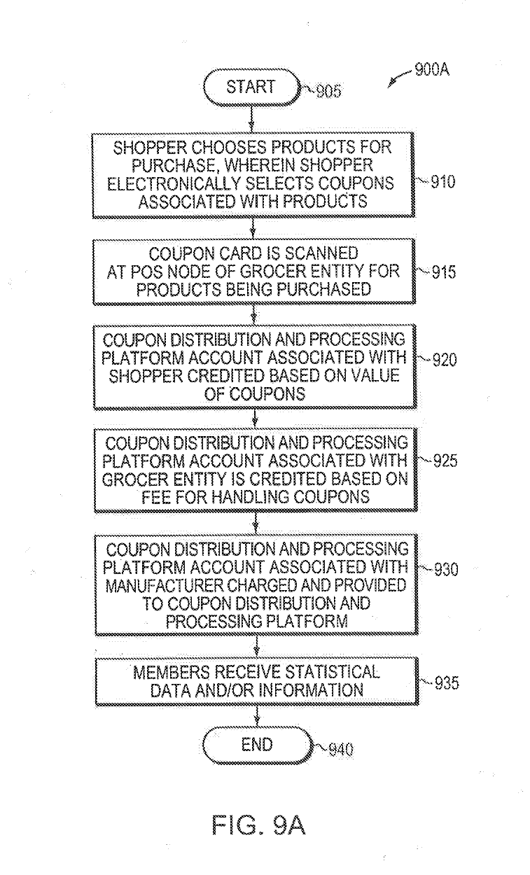

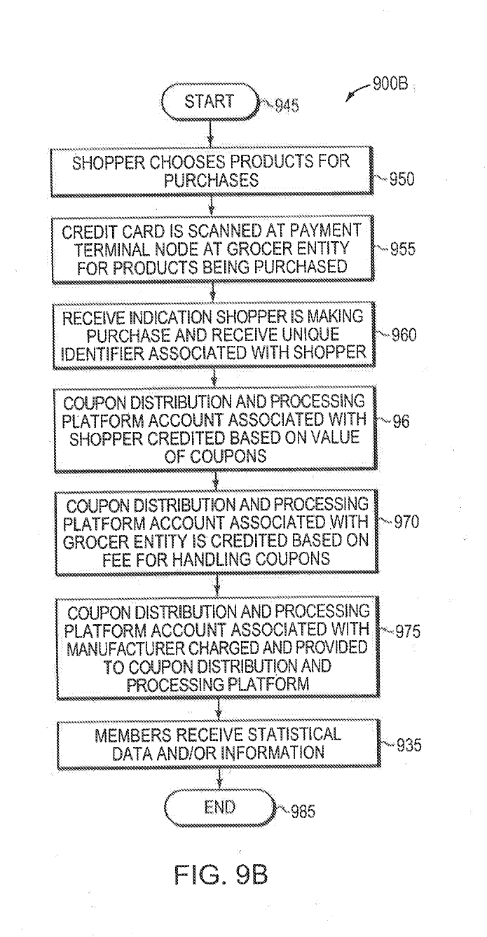

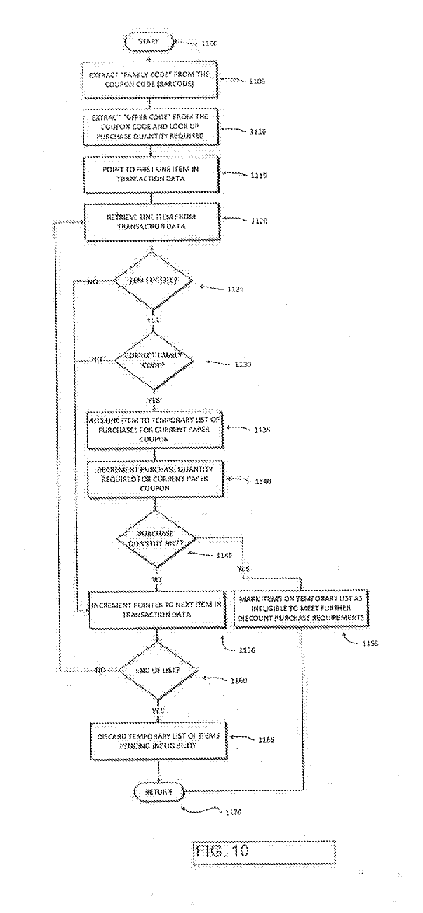

FIG. 9A is an exemplary flowchart detailing the steps of a procedure 900A for distributing and processing coupons in accordance in accordance with an illustrative embodiment of the present invention. Specifically, procedure 900 starts at step 905 and continues to step 910 where the shopper, having an account associated with the CDPP 108 and the coupon card 133, enters a grocer entity and selects one or more products for purchase. It is noted that the shopper may have previously electronically selected coupons, for products, that are associated with the shopper's coupon card 133, as described with reference to FIG. 8. Further, it is noted that the grocery entity and the manufacturer of the products both have accounts associated with the CDPP 108. The manufacturer may have requested specific services utilizing its corresponding account. For example, the manufacturer of laundry detergent may utilize its corresponding account to request that as shoppers enter particular grocery stores, the shoppers are to receive electronic promotions regarding the new laundry detergent. As such, when the shopper enters the grocery store, the shopper's mobile phone or other device may receive, from the CDPP 108, a message or image promoting the new laundry detergent over the cellular network 120.

At step 915, the shopper's coupon card 133 is scanned at POS node 116 of the grocer entity, such as a cash register, for the products purchased. Specifically, and as explained above, the POS node 116 has hardware and/or software loaded thereon. Thus, when the coupon card 133 is scanned at the POS node 116, the CDPP 108 can receive an indication that the shopper is making a purchase, and determines if the product purchased has a corresponding electronic coupon. For example the shopper may have previously selected electronic coupons (e.g., utilizing web pages associated with the CDPP 108) to be associated with the coupon card 133. In alternative embodiments, the manufacturer may have indicated that the shopper is to be automatically provided an electronic coupon for the product purchased without requiring the shopper to select the electronic coupon.

At step 920, the account associated with the shopper is credited based on the value of the coupon. The credit may be applied to the shopper's account in a manner selected by the shopper. For example, the shopper may have previously accessed his/her corresponding account and indicated that the credit or saving should be applied to a minimum payment requirement for a credit card. As such, the accumulated savings may be temporarily stored in a financial account maintained by a particular banking institution, and then applied to the minimum payment requirement for the credit card at a later time (e.g., end of the month). Alternatively, the shopper may have indicated that the credit or accumulated savings should be stored in a financial account associated with the shopper and maintained by a particular banking institution. In any case, by scanning the shopper's coupon card at the POS node 116 of the grocer entity, the shopper receives accumulated savings, based on the electronic coupons, and those accumulated savings are provided to the shopper in a manner selected by the shopper.

At step 925, the account associated with the grocer entity may be credited based on a fee for handling the coupon, wherein the account may be maintained by the banking institution. For example, if the shopper has utilized four electronic coupons previously selected and associated with its coupon card 133 when the coupon card 133 is scanned at the POS node 116, the financial account associated with the grocer entity may be credited (e.g., $0.08) based on a handling fee associated with each electronic coupon. Advantageously, the grocer entity 104 does not bear the financial burden associated with waiting until a coupon is compensated through a coupon settlement process, as is the case with tradition paper coupons. In addition, the grocer entity does not have to wait for a clearinghouse settlement process to take place and thus does not have to essentially carry the face value float of the coupon for an extended period of time. Instead, by being a member of the CDPP 108, the grocer entity avoids these encumbrances and is simply an un-acting intermediary that may receive financial compensation (e.g., handling fee) in a timely fashion.

At step 930, the financial account associated with the manufacturer may be charge/debited and provided to the CDPP 108. For example, the CDPP 108 may have a financial account maintained by a particular banking institution. In response to the scanning of the shopper's coupon card 133, the fee (e.g., $0.10) may be transferred from the financial account associated with the manufacturer to the financial account associated with the CDPP 108. As such, the four entities: the manufacturer, the grocer entity, the shopper, and the CDPP 108 are affected based on the scanning of the coupon card 133 at the POS node 116.

At step 935, the members (e.g., manufacturers, grocer entities, and shoppers) receives statistical data and/or information. As explained above, data associated with the POS node 116 may be captured and compiled by the hardware and/or software installed on the POS node 116, and transmitted to the CDPP 108 for organization and storage. Specifically, the manufacturer may access its corresponding account and view the captured data. Advantageously, the manufacturer can get real time statistics regarding the sale of its products at grocer entities, and utilize this information to alter its business practices. Further, the CDPP 108 may collect statistical data or survey data regarding shopper's tendencies, etc., and store such information on the CDPP 108. The grocer entity may access its corresponding account and view this information. Moreover, the shopper may receive promotional information or other data based on its buying patterns, after logging into the corresponding account. At step 940, the procedure ends.

FIG. 9B is an exemplary flowchart detailing the steps of a procedure 900B for distributing and processing coupons in accordance in accordance with an illustrative embodiment of the present invention. Specifically, procedure 900B starts at step 945 and continues to step 950 where the shopper, having an account associated with the CDPP 108, enters a grocer entity and selects one or more products for purchase. It is noted that the shopper may have previously electronically selected coupons, for products. Further, it is noted that the grocery entity and the manufacturer of the products both have accounts associated with the CDPP 108.

At step 955, the shopper's credit card 137 is scanned at payment terminal node 140 at the grocer entity, that is associated with the financial services institution node 110. At step 960, and in response to the credit card 137 being scanned, the CDPP 108 receives an indication that the shopper is making a purchase and receives from the financial services institution node 110 a unique identifier associated with the shopper.

At step 965, the account associated with the shopper is credited based on the value of the electronic coupon. For example, the shopper may have previously selected electronic coupons (e.g., utilizing web pages associated with the CDPP 108). In alternative embodiments, the manufacturer may have indicated that the shopper is to be automatically provided an electronic coupon for the product purchased without requiring the shopper to select the electronic coupon utilizing the CDPP 108.

At step 970, the account associated with the grocer entity may be credited based on a fee for handling the coupon, wherein the account may be maintained by the banking institution. At step 975, the financial account associated with the manufacturer may be charge/debited and provided to the CDPP 108. At step 980, the members (e.g., manufacturers, grocer entities, and shoppers) receives statistical data and/or information. At step 985, the procedure ends.

FIG. 10 is an exemplary flowchart detailing the steps of a procedure for preventing a purchased item from fulfilling the purchase requirements of more than one discount in accordance with various embodiments of the present invention. In some embodiments, the procedure 1100 can be used to mark items purchased as ineligible for purposes of meeting the purchase requirements of discount incentives granted through the system (DIMP or CDPP) because they have already been used for the purpose of meeting purchase requirements of a paper coupon which was scanned and for which a discount was already granted at the POS register. A calling function, having extracted the coupon code (e.g., barcode) of a paper coupon that was scanned at the POS register, can call procedure 1100 while passing the coupon code as a parameter. Specifically, procedure 1100 starts first with step 1105 and continues to step 1170 where it returns to the function from which it was called. At step 1105, the family code, as defined by GS1 specifications well known to those skilled in the art, is extracted from the coupon code parameter passed by the calling function. At step 1110, the offer code, as defined by GS1 specifications well known to those skilled in the art, is extracted from the coupon code parameter passed by the calling function, and the specific purchase quantity required to meet the terms of the coupon offer are retrieved from a table of offer codes, as defined by GS1 specifications well known to those skilled in the art.

At step 1115 the procedure points to the first line item contained in the data from the present checkout transaction and retrieves its product identification (GTIN) and the quantity purchased at step 1120. At step 1125, if the item has previously been marked ineligible (e.g., the item has already been used for purposes of qualifying for a coupon discount) the procedure skips ahead to step 1150. If the item is eligible, at step 1130 the item's product identification is compared to the family code of the current paper coupon; if the family code does not match, the item is not applicable to the current paper coupon and the procedure skips to step 1150.

Arrival at step 1135 indicates that the current item is eligible to be used for purposes of qualifying for a coupon discount and that it is of the correct product family. At step 1135 the transaction line item is appended to a temporary list of items that have been used to qualify for the current paper coupon. At step 1140 the purchase quantity required to meet requirements of the current paper coupon is reduced by the purchase quantity of the current item.

At step 1145 the procedure compares the remaining purchase quantity required in order to meet the requirements of the current paper coupon. If the requirements are not yet met, the procedure increments the pointer to the next line item in the transaction data. If one or more items remain in the transaction data, execution resumes back at step 1125. If there are no more items available in the transaction data, the purchase requirements of the paper coupon have not been met; the temporary list of items to be attributed to the current paper coupon is discarded, thus leaving any items that were on that list eligible for application to the purchase requirements of other paper coupons or discount incentives granted by the DIMP. At step 1170 execution returns to the calling function.

At step 1145, if the purchase quantity requirements of the current paper coupon have been met, execution skips to step 1155, where any items on the temporary list are marked as ineligible for purposes of meeting purchase requirements for subsequent paper coupons or discount incentives within the current checkout transaction. Thereafter, execution returns to the calling procedure at step 1170.

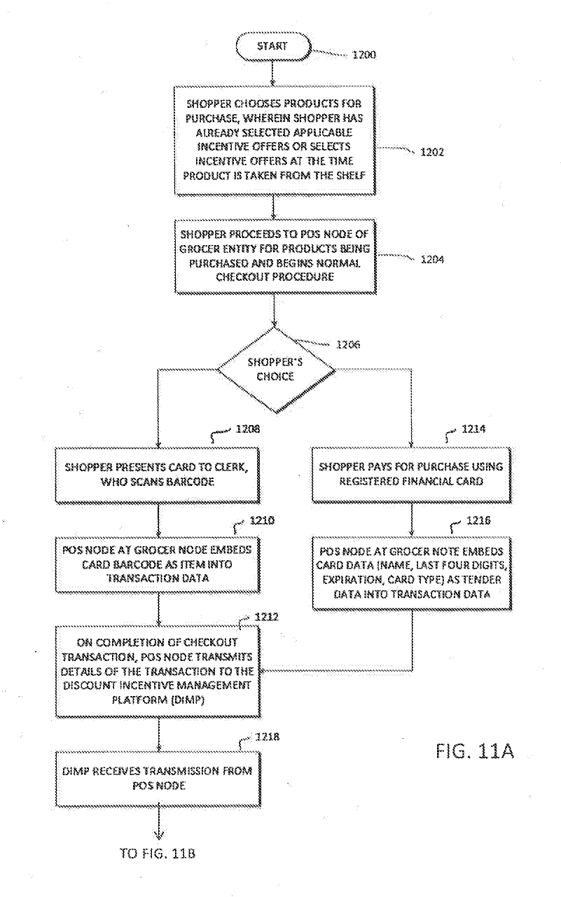

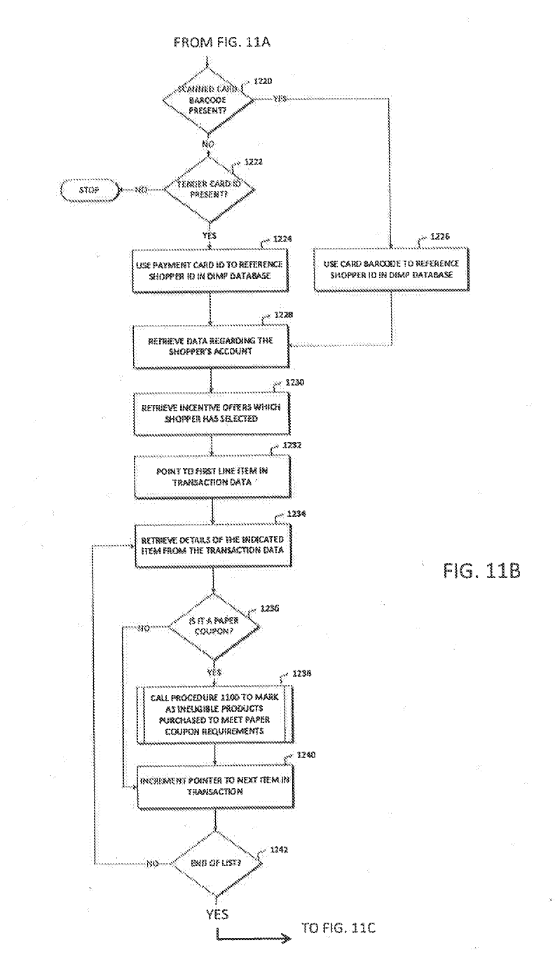

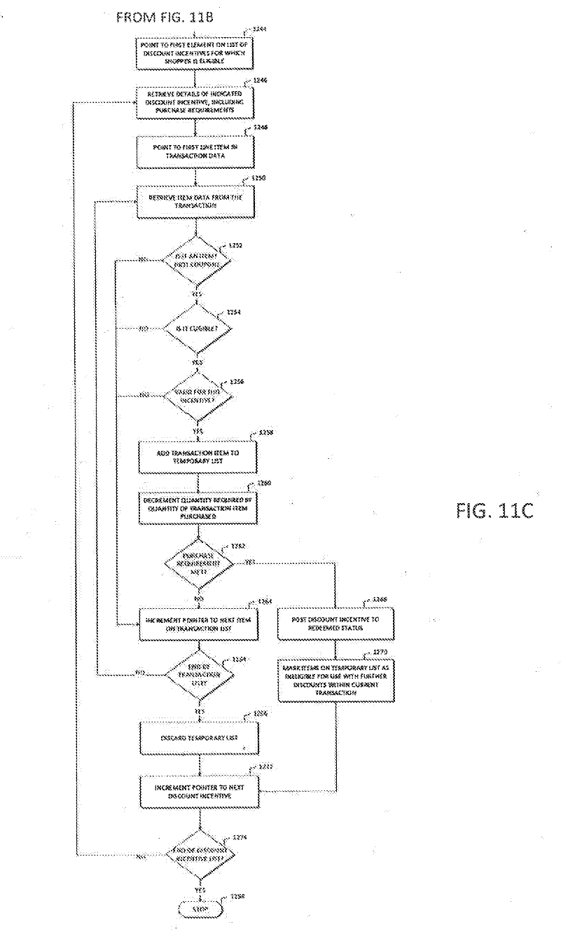

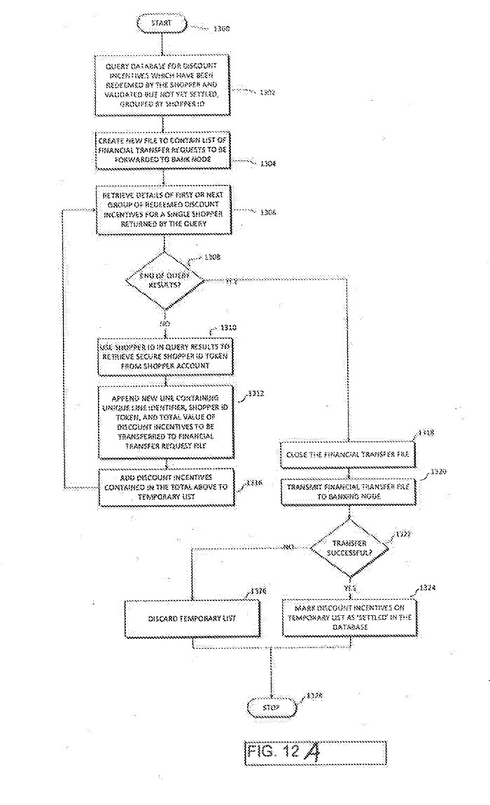

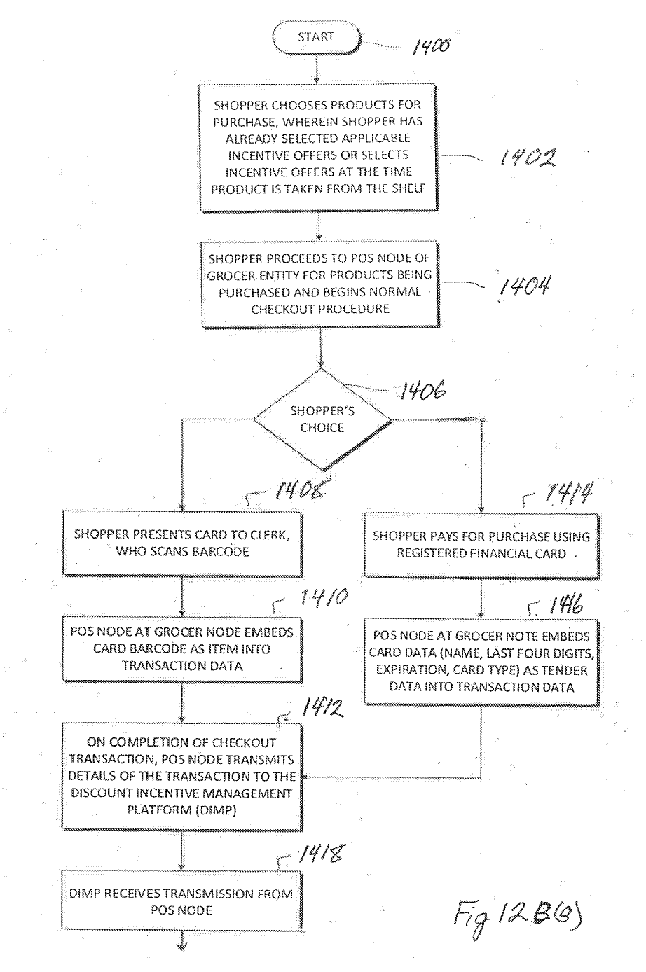

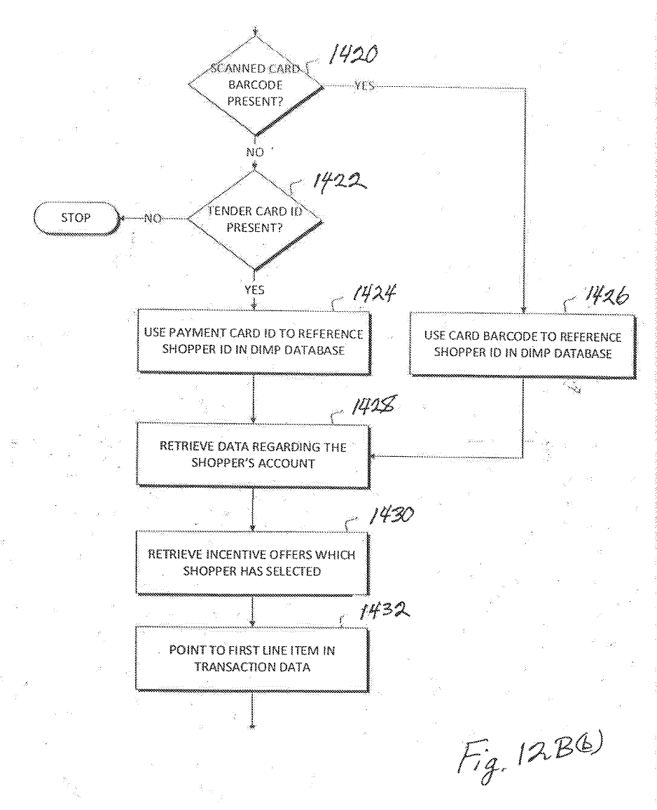

FIGS. 11A-11C are partial views of an exemplary flowchart 1200 illustrating a procedure for processing discount incentives in accordance with various embodiments of the present invention. The exemplary flowchart 1200 describes in greater detail some embodiments of procedures 900A and 900B described above. Specifically, the flowchart 1200 describes steps in which the shopper identification is captured at the POS node and transmitted to the DIMP in combination with details of the purchase transaction, and then processed to identify and record coupons or discount incentives earned by the shopper within the current purchase transaction. The shopper, having an account associated with the DIMP 108 and the membership card 133 or payment card 137 or mobile device used for payment 122, selects one or more products for purchase at a grocer entity at step 1202. It is noted that the shopper may have previously electronically selected discount incentives for products that are associated with the shopper's membership account. Further, it is noted that the grocery entity and the manufacturer of the products both have accounts associated with the DIMP 108. The manufacturer may have requested specific services utilizing its corresponding account. For example, the manufacturer of laundry detergent may utilize its corresponding account to request that as shoppers enter particular grocery stores, the shoppers are to receive electronic promotions regarding the new laundry detergent. As such, when the shopper enters the grocery store, the shopper's mobile phone or other device may receive, from the DIMP 108, a message or image promoting the new laundry detergent over the cellular network 120.

At step 1204, the shopper proceeds to the checkout station of the POS node and begins the checkout procedure. At step 1206 the shopper may elect to present their membership card 133 imprinted with a unique code or signature 135 to the clerk at step 1208. For example, the unique signature 135 can be a barcode that may be scanned by a barcode scanner connected to the POS node or the unique signature 135 can be a magnetic stripe or microchip electronic circuit that can be read by an element of the POS node. Alternatively, the shopper may elect to present their registered financial payment card 137 including unique signature 135 to the clerk for scanning in a similar manner at step 1208. In either of these cases, data encoded in the unique signature 135 is recorded at step 1210 by the POS node in the transaction data in the form of a retail item code (GTIN) with serial number field.

Alternatively, at step 1206 the shopper may elect to pay for their purchase with a registered financial card at step 1214. In that event, key identification elements encoded on the card are captured by the payment terminal node 140 and forwarded to the POS node 116, which at step 1216 embeds the card information as part of the payment tender information recorded in the transaction data. The key elements thus captured and recorded can include the name as encoded on the card, the last four digits of the card number, the expiration date in MMYY format, and a numeric or text code that identifies the type of card (Visa, MasterCard, etc.).

At step 1212, on completion of the checkout transaction, the POS node transmits data about the transaction to the DIMP which receives the data at step 1218.

At step 1220 the DIMP scans the list of item barcodes (GTIN codes) contained in the transaction data. As known to those familiar with the art, the leading digits of a GTIN comprise the manufacturer ID and are unique to an individual manufacturer, business entity, or barcode owner; by seeking the manufacturer or entity ID(s) known to be associated with DIMP cards, the DIMP can readily identify the presence of such a code in the transaction data. If such a GTIN is found, the DIMP uses the number to reference and retrieve the shopper ID of the associated shopper in step 1226. These procedures can be utilized in conjunction with mobile device payment methods as well. For example, a mobile device can comprise an NFC enabled wireless phone in which an NFC circuit includes a controller configured to transmit user identification data to an NFC reader.

Alternatively, if at step 1220 the DIMP does not find a member card barcode embedded in the transaction items, at step 1222 it scans the transaction data seeking payment tender information that may have been captured by the POS node at step 1216. If payment card data is found in the transaction, at step 1224 the DIMP uses this information to reference and retrieve the shopper ID of the associated shopper.

If at step 1222 no payment card data is found, the process for this particular transaction stops, as the identification of the shopper is not embedded in the transaction data sent by the POS node, and without shopper identification it is not possible to identify and allocate discount incentives correctly.

At step 1228 the DIMP uses the shopper ID retrieved at either step 1224 or step 1226 to retrieve data regarding the shopper's account from the DIMP database. At step 1230, the DIMP retrieves a list of discount incentives which the shopper has previously selected, or which are available to the shopper without prior selection according to the rules specified by the sponsoring manufacturer.

At step 1232, the DIMP sets a pointer to the first line item contained in the transaction data, and at step 1234 retrieves that data. At step 1236, the DIMP analyzes the GTIN of the item and determines if it is a paper coupon. If it is a paper coupon, the DIMP calls procedure 1100 (as described above with respect to FIG. 10) to identify purchased items on the current transaction that were used to meet purchase requirements for the paper coupon and to mark those items as ineligible to be used to meet purchase requirements for other incentives. At step 1240 and 1242, the DIMP increments the pointer noted above to move down the list of all items on the transaction and process each as noted above until the end of the list is reached.

At step 1244, having marked as ineligible all purchased items that were used to qualify for paper coupon discounts already granted (redeemed) at the POS node, the DIMP points to the first element on the list of discount incentives which the shopper has selected. At step 1246, the DIMP retrieves the details of the discount incentive, including requirements for what items must be purchased to satisfy the terms of the offer.

Beginning at step 1248, the DIMP points to the first item on the list of items purchased on the transaction and retrieves details from the transaction data, including the GTIN of the item and the quantity purchased. At step 1252, the DIMP analyzes the GTIN; if it is a coupon code, execution skips ahead to step 1264 where the pointer is incremented to the next item on the list. Having determined that the GTIN is for a purchased item, the DIMP notes if the item has already been flagged as ineligible, indicated that the item has been previously used to meet purchase requirements for a paper coupon redeemed at the register or for another discount incentive during an earlier iteration of the present loop. At step 1256, the DIMP determines if the current item is specified by the sponsoring manufacturer of the current discount incentive as one that may be used to satisfy purchase requirements. If the item is valid for the current discount incentive, at step 1258 the DIMP adds to a temporary list a reference to the item as listed in the transaction data. At step 1260 the DIMP then decrements the quantity of items that must be purchased in order to satisfy the requirements of the current discount incentive. At step 1262 the DIMP determines if the purchase requirements for the current discount incentive have been met. If purchase requirements have not been met, at step 1264 increments the pointer to the next item on the transaction list. If the end of the transaction list has not been reached, execution resumes at step 1250, and the DIMP checks the next item. If, however, at step 1264 the end of the transaction list has been reached, the quantity of valid item purchases required by the current discount incentive have not been met; at step 1266 the system discards the temporary list of references to the transaction data, thus releasing the referenced items on the list for use with further discount incentives that may be available. At step 1272 the pointer to the list of discount incentives is increments, and at step 1274 if the end of the list of available discount incentives has not been reached, execution resumes at step 1250.

At step 1262, if the system determines that the purchase requirements for the current discount incentive have been met, at step 1268 the DIMP posts the current discount incentive so as to mark it in the database as redeemed and ready for financial settlement. At step 1270, the DIMP marks in the transaction data the items referenced on the temporary list to indicate that they have been applied to satisfy the purchase requirements of the current discount incentive and are no longer available to meet the purchase requirements of other discount incentives.

Procedure 1200 ends at step 1298 after all selected discount incentives have been checked against all items purchased on the current transaction.

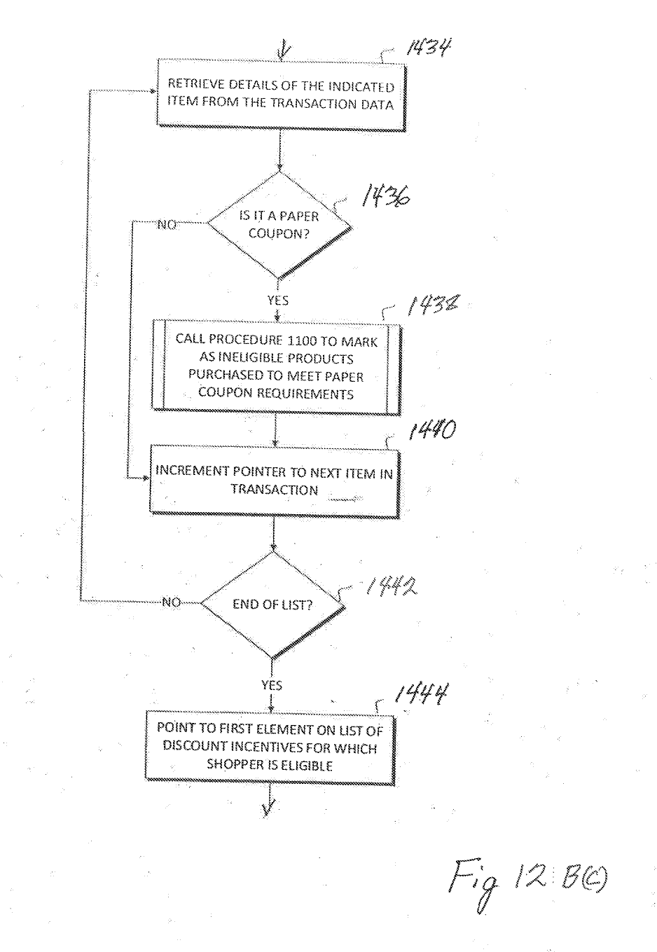

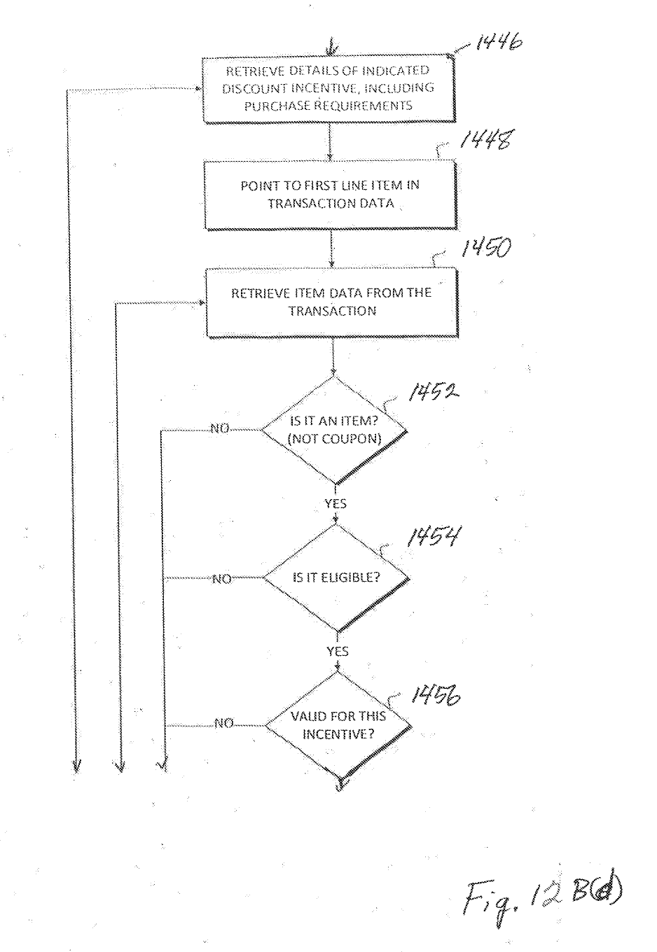

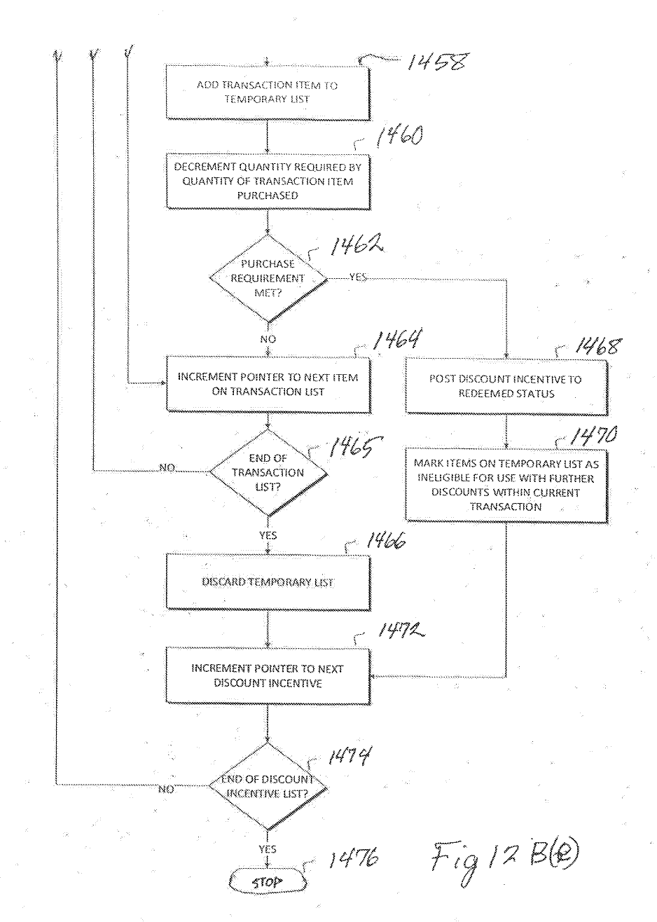

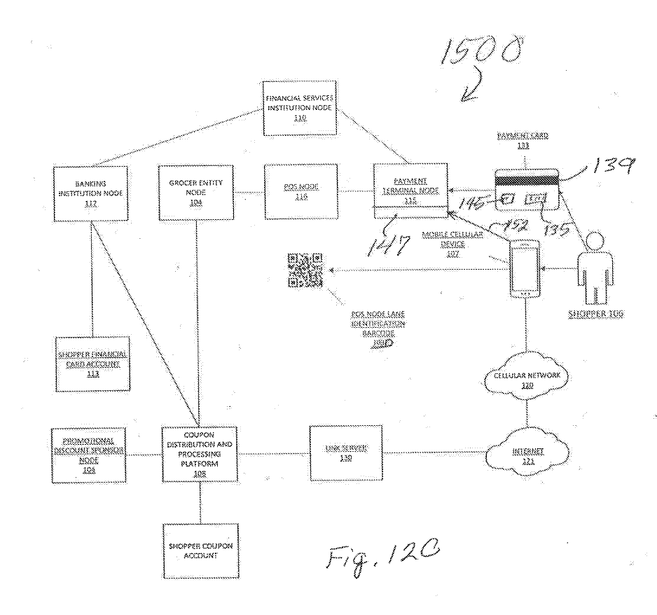

FIG. 12A is an exemplary flowchart that details the steps used by the DIMP to initiate transfer of funds at the banking node in order to financially settle discount incentives which have been redeemed by the shopper and validated by the DIMP. The procedure begins at step 1300, having been initiated according to a prescribed time interval.

At step 1302, the DIMP queries the database for a list of discount incentives that have been redeemed by the shopper (that is, discount incentives which the shopper has selected or for which the shopper is eligible without selection, and for which the shopper has met the terms of the discount incentive offer by purchasing the items specified) and validated by the DIMP in previous procedures, but not yet financially settled. The query specifies that the returned data elements will be grouped by shopper ID.

At step 1304, the DIMP creates a new file that contains the financial transfer requests created by the current procedure.

At step 1306, DIMP retrieves the data contained in the next element returned by the query. In the first iteration, the data returned is for the first element returned; in subsequent iterations, the data returned is for the next available element. On the final iteration, the attempt to retrieve the next element (step 1306) returns an indication that the end of the query results has been reached.

At step 1308, if a data element has been returned from the query, execution moves to step 1310, where the DIMP uses the shopper ID contained in the query result to access the shopper account and retrieve the secure shopper identification token. The shopper identification token serves as a shared identifier for the shopper (secured identifier), known to both the DIMP and the banking node.

At step 1312, the DIMP appends a new line to the file containing financial transfer requests (created at step 1304), with the line containing a unique line identification code for future reference, the secure shopper id token, and the total amount of discount incentives to be credited to the shopper's financial account. At step 1316, the DIMP adds the discount incentives referenced in the database query and appended to the financial transfer file at step 1312 to a temporary list. Execution loops back to step 1306, where the next element is retrieved from the query.

At step 1308, if the end of the query results has been reached, execution resumes at step 1318, where the DIMP closes the file which contains the financial transfer requests. At step 1320, the DIMP transfers the financial transfer request file to the banking node using standard methods for secure transfers of data via the internet.

At step 1322, the DIMP verifies that the transfer has been completed successfully. If the transfer was successful, at step 1324 the DIMP references the temporary list of discount incentives, compiled at step 1316, and marks each of the discount incentives in the database as ‘settled’.

If the transfer is not successful, at step 1326 the DIMP discards the temporary list of discount incentives (compiled at step 1316), thereby leaving their status in the database unchanged (not yet settled) at termination 1328.

FIG. 12B is an exemplary flowchart that describes in greater detail procedures exemplified by 900A and 900B, above. Specifically, the steps in which the shopper identification is captured at the POS node and transmitted to the DIMP in combination with details of the purchase transaction, and then processed to identify and record discount incentives earned by the shopper within the current purchase transaction. The shopper, having an account associated with the DIMP 108 and the membership card 133 or the payment card 137, enters a grocer entity and selects one or more products for purchase at step 1402. It is noted that the shopper may have previously electronically selected discount incentives for products that are associated with the shopper's membership account. Further, it is noted that the grocery entity and the manufacturer of the products both have accounts associated with the DIMP 108. The manufacturer may have requested specific services utilizing its corresponding account. For example, the manufacturer of laundry detergent may utilize its corresponding account to request that as shoppers enter particular grocery stores, the shoppers are to receive electronic promotions regarding the new laundry detergent. As such, when the shopper enters the grocery store, the shopper's mobile phone or other device may receive, from the DIMP 108, a message or image promoting the new laundry detergent over the cellular network 120.

At step 1404, the shopper proceeds to the checkout station of the POS node and begins the checkout procedure. At step 1406 the shopper may elect to present their membership card 133 imprinted with a barcode 135, or other coded identifier provided by machine readable code or by electronically stored code or encrypted electronic signal, to the clerk so that the barcode may be scanned by the barcode scanner connected to the POS node at step 1408. Alternatively, the shopper may elect to present their registered financial payment card 137 imprinted with machine readable code 135 to the clerk for scanning in the same manner at step 1408. In either of these cases, the barcode scanned from the card presented is recorded by the POS node at step 1410 in the transaction data in the form of a retail item code (GTIN) with serial number field.

Alternatively, at step 1406 the shopper may elect to pay for their purchase with a registered financial card or mobile phone at step 1414. In that event, key identification elements encoded on the card or phone memory are captured by the payment terminal node 140 and forwarded to the POS node 116, which at step 1416 embeds the card information as part of the payment tender information recorded in the transaction data. The key elements thus captured and recorded are the name as encoded on the card, the last four digits of the card number, the expiration data in MMYY format, and a numeric or text code that identifies the type of card (Visa, MasterCard, etc.).

Alternatively, at step 1416 the POS node 116 may encode the payment tender information using a cryptographic hash function as known to those skilled in the art. An example of a suitable hash function is the “SHA256” method which, given input concatenated from a unique instance card type, last four digits of the card number, expiration date in MMYY format, and name as printed on the card and encoded on the card's magnetic stripe and encoded on the card's EMV chip, if present, yields a code word unique to the input data which cannot be reversed to disclose the information from which it was created. Even though the limited payment tender information, which omits the leading digits of the card number, is generally considered non-sensitive and may be transmitted from the POS system to the DIMP “in the clear” without violating payment card industry security guidelines, the cryptographic hash method provides an additional level of security. If the cryptographic hash method is used by the POS node 116 to encrypt payment tender information, the DIMP 108 matches the code word received from the POS node against code words which the DIMP 108 has generated independently utilizing payment card information provided by the shopper at the time they registered their card.

At step 1412, on completion of the checkout transaction, the POS node transmits data about the transaction to the DIMP which receives the data at step 1418.

At step 1420 the DIMP scans the list of item barcodes (GTIN codes) contained in the transaction data. As known to those familiar with the art, the leading digits of a GTIN comprise the manufacturer ID (or generally a discounting entity or source and its account) and are unique to an individual manufacturer or barcode owner; by seeking the manufacturer ID(s) known to be associated with DIMP member cards, the DIMP can readily identify the presence of such a code in the transaction data. If such a GTIN is found, the DIMP uses the number to reference and retrieve the shopper ID of the associated shopper.

Alternatively, if at step 1420 the DIMP does not find a member card barcode embedded in the transaction items, at step 1422 it scans the transaction data seeking payment tender information that may have been captured by the POS node at step 1416. If payment card data is found in the transaction, at step 1424 the DIMP uses this information to reference and retrieve the shopper ID of the associated shopper.

If at step 1422 no payment card data is found, the process for this particular transaction stops, as the identification of the shopper is not embedded in the transaction data sent by the POS node, and without shopper identification it is not possible to identify and allocate discount incentives correctly.

At step 1428 the DIMP uses the Shopper ID retrieved at either step 1424 or step 1426 to retrieve data regarding the shopper's account from the DIMP database. At step 1430, the DIMP retrieves a list of discount incentives which the shopper has previously selected, or which are available to the shopper without prior selection according to the rules specified by the sponsoring manufacturer.

At step 1432, the DIMP sets a pointer to the first line item contained in the transaction data, and at step 1434 retrieves that data. At step 1436, the DIMP analyzes the GTIN of the item and determines if it is a paper coupon. If it is a paper coupon, the DIMP calls procedure 1100, which identifies purchased items on the current transaction which were used to meet purchase requirements for the paper coupon, and marks those items as ineligible to be used to meet purchase requirements for other incentives. At step 1440 and 1442, the DIMP increments the pointer noted above to move down the list of all items on the transaction and process each as noted above until the end of the list is reached.

At step 1444, having marked as ineligible all purchased items that were used to qualify for paper coupon discounts already granted (redeemed) at the POS node, the DIMP points to the first element on the list of discount incentives which the shopper has selected. At step 1446, the DIMP retrieves the details of the discount incentive, including requirements for what items must be purchased to satisfy the terms of the offer.

Beginning at step 1448, the DIMP points to the first item on the list of items purchased on the transaction and retrieves details from the transaction data, including the GTIN of the item and the quantity purchased. At step 1452, the DIMP analyzes the GTIN; if it is a coupon code, execution skips ahead to step 1464 where the pointer is incremented to the next item on the list. Having determined that the GTIN is for a purchased item, the DIMP notes if the item has already been flagged as ineligible, indicated that the item has been previously used to meet purchase requirements for a paper coupon redeemed at the register or for another discount incentive during an earlier iteration of the present loop. At step 1456, the DIMP determines if the current item is specified by the sponsoring manufacturer of the current discount incentive as one that may be used to satisfy purchase requirements. If the item is valid for the current discount incentive, at step 1458 the DIMP adds to a temporary list a reference to the item as listed in the transaction data. At step 1460 the DIMP then decrements the quantity of items that must be purchased in order to satisfy the requirements of the current discount incentive. At step 1462 the DIMP determines if the purchase requirements for the current discount incentive have been met. If purchase requirements have not been met, at step 1464 increments the pointer to the next item on the transaction list. If the end of the transaction list has not been reached, execution resumes at step 1450, and the DIMP checks the next item. If, however, at step 1465 the end of the transaction list has been reached, the quantity of valid item purchases required by the current discount incentive have not been met; at step 1466 the DIMP discards the temporary list of references to the transaction data, thus releasing the referenced items on the list for use with further discount incentives that may be available. At step 1472 the pointer to the list of discount incentives is increments, and at step 1474 if the end of the list of available discount incentives has not been reached, execution resumes at step 1450.

At step 1462, if the DIMP determines that the purchase requirements for the current discount incentive have been met, at step 1468 the DIMP posts the current discount incentive so as to mark it in the database as redeemed and ready for financial settlement. At step 1470, the DIMP marks in the transaction data the items referenced on the temporary list to indicate that they have been applied to satisfy the purchase requirements of the current discount incentive and are no longer available to meet the purchase requirements of other discount incentives.

Procedure 1400 ends at step 1476 after all selected discount incentives have been checked against all items purchased on the current transaction.

Manufacturers and dealers in consumer products seek to influence shopper purchase behavior by offering discount incentives which benefit the shopper if they purchase particular products being promoted by the sponsor as generally described herein.

Upon purchasing a product that qualifies for a promotional benefit, shoppers may receive their benefits by a cash discount at the register upon presentation of a manufacturer's discount coupon, by submitting a rebate form accompanied by proof of purchase to the manufacturer, or by an electronic settlement mechanism that associates the shopper with the purchase and deposits the benefits directly to the shopper's financial account. The latter method is implemented by the SMDI referenced above, and is the method addressed by the current invention.

It is common for a shopper, when paying for a purchase, to pay by means of a payment card which is associated with an underlying bank account from which funds will be electronically withdrawn to cover the cost of the purchase. The data communications involved in making such a payment begin with a payment terminal (PT) which is attached to the point-of-sale cash register system (POS).

The POS system transmits to the PT the amount due for the purchase. The shopper swipes or inserts their payment card in the PT and provides a personal identification number (PIN) if required. The PT securely transmits to the banking system the card account details and total amount of the purchase needed to settle the transaction; these transmissions do not include any details of the specific items purchased in the transaction.

The PT transmits to the POS system confirmation of the payment, including the amount successfully tendered and redacted information about the payment card used. The redacted information typically includes the type of card (Visa, Master Card, etc.), the last four digits of the card number, the expiration date (month and year), and the cardholder's name as printed on the card. The redacted information is insufficient for the POS system or any attached system to positively identify a specific card account in the absence of prior knowledge of the redacted information.

For any promotional benefits settlement system to function properly, it is necessary for that system to have previously established a logical link between the payment card which may be used by a particular user with personal identification information about the shopper. This linkage may be used for several purposes:
1. Provide the promotional benefits system with information sufficient to identify the issuing bank and the specific card account for purposes of transferring cash benefits earned by the shopper into the shopper's card account.
2. Enable the promotional benefits system to identify the shopper who has made a purchase using a financial card for payment from the redacted payment card information recorded by the POS system, this in the absence of alternative means of shopper identification such as, for example, scanning a membership identification barcode at the POS register.

It is generally not permissible for the bank or other financial institution which issued the financial card to communicate any information about the card or cardholder to the promotional benefits system. It is therefore necessary for the logical linkage between the financial card and the shopper information retained by the promotional benefits system to be established by the shopper through a one-time registration process in which the shopper provides both the redacted card information and information sufficient to personally identify himself or herself.

One method of registration utilizes an on-line data entry form (or set of forms) through which the user provides the redacted card information and their personal identification information. Two difficulties with this approach include, but are not necessarily limited to:
1. The shopper must make a deliberate effort to navigate on-line to the registration screen and provide the requested information.
2. The redacted card information must be entered precisely and accurately. Any errors or omissions in this data, entered manually by the shopper (cardholder), will result in a failure to correctly match the card at the time the benefits system attempts to identify the shopper from the payment card used for a transaction and when the system attempts to transfer benefits to the shopper's card account.

The present invention provides a means by which a shopper can register their payment card during the course of a checkout transaction, thus eliminating the need for a separate effort to navigate to an on-line registration page; and utilizing the redacted payment card information as read electronically by the payment terminal and reported to the POS system, thus eliminating human data entry errors.

The following description references the embodiment of the system 1500 shown in FIG. 12C. A shopper or user 106 is in possession of a payment card 133 which has not been previously registered with the coupon distribution and processing platform (CDPP) 108. The shopper or user 106 is also in possession of a mobile cellular device 107 which they use as their primary mobile telephone. The payment card device can include a machine readable code 135 such as a barcode, a magnetic strip 139 sufficient to perform a payment transaction as set forth herein and/or an electronic chip or circuit 145 mounted on the card to perform encrypted payment and data communication as described herein. The mobile communication device 107 can perform transactions 152 at the scanner 147 associated with payment terminal 115. The device 107 can comprise a cellular phone that connects to the internet 121 using cellular network 120 to access server 130. The server 130 is configured to access the discount data processing system 108 as generally described herein. Mobile device 107 can perform secure payment transactions using a near field communication (NFC) device.

Shopper or user 106 presents items for purchase at checkout station POS node 116 on the premises of participating retailer node 104. As the clerk employed by the retailer begins scanning the items to be purchased, the shopper 106 is informed by the clerk, by signage at POS node 116, or by other means that if they and/or their payment card are not currently registered with the CDPP 108 they may register quickly:

Shopper 106 uses their mobile cellular device 107 to take a picture (“scan”) POS node lane identification barcode 1080. For descriptive purposes, this is shown as a “QR Code”, a form of two-dimensional barcode that, in current practice, is readily scanned and processed by most mobile cellular devices available to the market. In practice, the lane identification information can be encoded in any type of device that can be scanned or read by a mobile device (for example, radio frequency identification (RFID) tag or a near field communication circuit (NFC)).

The data encoded in POS node lane identification barcode 108 includes: a) a digital address which, within the context of the cellular telephone system and the internet, resolves to a server address assigned to the link server 130; b) a code word or number that uniquely identifies the specific checkout lane (POS node 116) and retailer (retailer node 104); c) a command code generally used by mobile telephones to trigger a text message transmission. The terminal 115 can be connected to or include a scanner 147 that can scan the barcode, can communicate with an electronic circuit 145 on the card having stored user identification data, bank account data to facilitate the payment transaction or a near-field communication device (NFC) to enable a payment transaction occur that also facilitates the discounted transaction based on electronically stored discount information for certain products or services being purchased. The system provides for secure processing of a discounted transaction where the terminal includes a scanner such that the terminal forms packetized data for transmission including data fields containing the user identification, sale location, product or service and associated discount data.

The result of scanning the POS node lane identification barcode 108 is that mobile cellular device 107, through functionality considered to be standard with the current state of the art, constructs a text message containing several elements: the telephone number associated with the mobile cellular device 107, the identification for the checkout lane and retailer as encoded in the lane identification barcode 1080, and the date and time at which the message was constructed. This message is transmitted to the destination address encoded in lane identification barcode 107. Upon receiving this message, the link server 130 records in a database the information as encoded in the message.

At the checkout lane, once all selected items have been scanned and the total amount due calculated, shopper 106 may elect to pay using payment card 133. Shopper 106 inserts or swipes payment card 133 at payment terminal 115. Once payment has been confirmed by the financial services institution node 110, payment terminal 115 sends confirmation to the POS node 116, including redacted payment card information (type of card, last four digits of the card number, expiration month and year, and the name on the card).

The complete record of the checkout transaction, including the redacted card information and the date/time at which the checkout transaction occurred, is stored by POS node 116 on the data system used by retailer entity node 104. As an active participant in a promotional coupons program, a copy of the transaction details is concurrently forwarded to the CDPP by POS node 116.

For purposes of the following description we will stipulate that the shopper has not previously registered themselves or their payment card with the CDPP. Note the further condition that the user is not identified within the transaction data by a scanned “membership barcode”, manually-entered telephone number, or any other identification other than the redacted payment card information captured by the payment terminal 115.

The CDPP 108 processes the received transaction and determines that no shopper or user identification is available other than the redacted payment card information, of which it has no prior record.

The CDPP 108 communicates with the link server 130, providing the last four digits of the card number, the date/time of the checkout transaction, the retailer entity node 104 at which the purchase was made, and the total amount of the purchase. In addition, the CDPP 109 includes an identification code that uniquely identifies this specific transmission.

The link server 130 matches the information provided by the CDPP 108 to a previously recorded lane identification barcode scan (physical location) and the date/time of the transaction.

Having made this match, the link server 130 sends a text message to the shopper's mobile cellular device which was used to scan the lane identification barcode, inviting the shopper to complete their registration by clicking on an internet link included in the text message.

By clicking on the link, the shopper is taken to a series of on-line forms generated by the link server:
a) The shopper is asked to verify that the match is correct by providing confirmation that they shopped at the retail facility in question. They may also be asked to provide confirming data known to the link server 130, such as the total amount of the purchase and the last four digits of the card used to make payment.
b) The shopper is asked to provide such personal information as may be needed to identify them and to profile their personal characteristics for marketing and promotional purposes.
c) The shopper is asked to provide information about their payment card sufficient for the CDPP to identify the correct issuing bank and the specific account to which earned promotional rewards will be deposited. If the operator of the CDPP has a working relationship with the issuing bank, the redacted card information already held by the CDPP will be sufficient to positively identify the account to the issuing bank.
d) The shopper is asked to explicitly agree to participation in the program and to all terms and conditions associated with the program.

When the shopper clicks to submit the provided information, the link server 130 forwards the data to the CDPP 108, including the unique identification code provided by the CDPP 108 when it made its request to the link server 130.

The CDPP 108, matching the unique identification code contained in the response to the initial request, combines the information provided by the link server 130 with the information already on file in the CDPP 108. The following information elements are now on file within the CDPP 108, having been captured electronically, without manual entry errors:
a) The name of the card holder (from the payment card)
b) The type of card (Visa, Master Card, etc. from the payment card)
c) The expiration month and year (from the card)
d) The card holder name as printed/encoded on the card (from the card)
e) The primary cellular telephone number used by the shopper (from the phone)

A further embodiment provides devices and methods by which cooperating entities may securely identify specific financial card accounts (debit cards and credit cards) in digital transmissions without exposing the underlying bank account numbers to the risk of compromise should the transmission be intercepted. This also eliminates the need for cooperating entities other than the financial institution which holds the accounts to receive or store the actual bank account numbers, thus removing the risk of account number exposure in the event of a database compromise.

Upon purchasing a product that qualifies for a promotional benefit, shoppers may receive their benefits in the form of a cash discount at the register upon presentation of a manufacturer's discount coupon. A transaction of this type generally requires only that the user or shopper is in possession of a valid promotional coupon and that the items being purchased meet the requirements stipulated by the terms of the coupon. There is no inherent requirement that the user identify themselves.

Traditional rebate methods deliver the benefit to the shopper after the purchase transaction is complete. These methods may include, for example, submission by the shopper to the manufacturer or their agent a rebate form accompanied by proof of purchase. This method has typically involved submission of physical items, such as cash register receipt, rebate form, and a piece removed from the original product packaging to verify that the shopper or user has taken physical possession of the item.

Newer methods deliver financial rewards directly to the shopper's financial card account by fully electronic means. For such systems, to properly verify and allocate promotional rewards, it is necessary for participating entities (“Participants”) to share identification of the shopper among themselves: the point of sale (“POS”) system at the retail store, the present system which processes the rewards, and the banking institution which has issued the shopper's financial card (“Issuing Bank”).

The current invention describes a shared anonymized card identifier (“SACI”) which comprises a block of binary data that can be used as a token to securely identify an individual shopper or user among the participants while at the same time protecting the user's identity and financial card information even in the event of interception of a data transmission or compromise of a database. The mobile device 107 can provide for payment and recording of discounts simultaneously using this encrypted method. The SACI exhibits the following key characteristics:
1. Constructed from data that is available independently to each participant
2. Uniquely and reliably identifies individual debit/credit cards and the card holder
3. Does not contain the account number, cardholder name, or other sensitive information
4. Cannot be decrypted or cracked to reveal the raw data from which it was constructed

Although the SACI is constructed using redacted information about the financial card which is held by the user, the one-way encryption method used to construct the SACI makes it difficult or impossible to decrypt the SACI into the original redacted card information from which it was derived. There is no decryption key.

When information is transmitted between participants, the transmitting entity dynamically creates or retrieves from data storage the SACI which specifically identifies the user account which is the subject of the transmission. The SACI serves as the only card holder identifier in the transmission.

The receiving entity must match the received SACI against a list of SACIs which they have generated using redacted card information which they have previously obtained from the card holder by means of an independent registration process.

The SACI is constructed from four pieces of input data:
is 1. Type of Card, including but not limited to the following examples:
   a. MC=Master Card
   b. VISA=Visa
   c. AMEX=American Express
   d. DISC=Discover
2. The card holder name as printed or embossed on the face of the card
3. The last four digits of the debit/credit card number
4. Expiration date in MMYY format
   This information is independently available to each participant; for example:
1. The retailer POS System captures this data from the payment terminal at the time payment is made using a financial card
2. The SMDI captures this information from the card holder during a one-time registration process
3. The Issuing Bank captures this information from the card holder during the card application process
   First, the raw pieces of redacted data are concatenated into a single string:

<type of card><cardholder name><last four digits><expiration>

For example:
Card type: MC (from above list of abbreviations, above)
Cardholder name: JOE P DOAKS (upper case, leading/trailing spaces removed)
Card Number: 5874 (last four digits)
Expiration: 0915 (four digits, MMYY)
   This sample information concatenates to:

MCJOE P DOAKS58740915

This string is then used as input to a SHA256 cryptographic hash function, producing a 256-bit result (32 bytes). It is a standard practice to transmit or print the SHA256 as a 64-character hexadecimal string or alternatively as a base-64 alphanumeric string. For example:

The SHA256 algorithm is extremely strong; there is no known way to decode the resulting hash back into the data from which it came. Further details regarding secure hash algorithms can be found in FIPS PUB 180-4 on the Secure Hash Standard (August 2015) at http://dx.doi.org/10.6028/NIST.FIPS.180-4 or at http://nvlpubs.nist.gov/nistpubs/FIPS/NIST.FIPS.180-4.pdf and also from the Information Technology Laboratory, National Institute of Standards and Technology, Gaithersburg, Md. 20899-8900. A system receiving data containing SACI's must compute (or have previously computed) SACI's for each of the cards it has on file. It can then match incoming SACI's against the list of SACI's that it has computed to find a specific card.

A complete explanation of secure hash algorithms, and the SHA-256 secure hash algorithm in particular, can be found in Section 6.2 of Federal Information Processing Standards Publication 180-4 (“FIPS 180-4”) noted above of which a summary follows:

A “Secure Hash Algorithm” (SHA) is a one-way iterative method of computing a condensed representation of an electronic message; the output of a SHA is called a “message digest”. The SHA-256 algorithm is so named because the message digest which it produces can be 256 bits in length, for example.

SHA algorithms are called “secure” because it is computationally infeasible to 1) extract the original message from the message digest or 2) find two different messages that produce the same message digest. The SHA-256 algorithm can be used to hash messages of lengths less than 2⁶⁴ bits (approximately 2.3 quintillion characters).

The message is padded so that its length is a multiple of 512 bits (FIPS 180-4, Section 5.1.1). It is then parsed into 512-bit long blocks (FIPS 1804, Section 5.2.2). An initial value is set to values obtained by taking the first thirty-two bits of the fractional parts of the square roots of the first eight prime numbers. Taken together, these are the initial hash value (FIPS 180-4, Section 5.3.3).

Then each block in the message is processed per FIPS 180-4, Section 6.2.2 to produce the final 256-bit output.

The following examples all use MC as the card type. Note that even small changes in the input data produce dramatically different output (SMITH vs. SMITHE, for example).

| CARDHOLDER | LAST | EXPR | SHA256 HASH |
|---|---|---|---|
| JOE P DOAKS | 5874 | 0915 | a0b4a6763760c86b2d4def932b17c7e5d0f72905537fc2e70b4836d0acf99b9e |
| JOHN SMITH | 5594 | 0915 | 04417c5325b3670bc61f9fad70b9ecfc2d9cdb4b9bd0e725487091b94c87467e |
| JOHN SMITH | 5594 | 1015 | 6d938d818d6014a84af6aad59c8486e0d45b871f60214ebc6a51ac1005e64f70 |
| JOHN SMITH | 4448 | 0915 | cc01f4700cf4686dcb255cedfacfc8aa887d3d703338f784b632627e90e6dfba |
| JOHN SMITHE | 4448 | 0915 | 535b79795189552a89973ac53353a046a56519b98b81fce699d938d3724858bf |

The following example illustrates an implementation of SACI generation using the Microsoft .Net (“dot net”) framework and the C# (“C-Sharp”) programming language:

```
using System;
using System.Security.Cryptography;
private static void Main( )
{
    Console.WriteLine(“saci - generate sample SACI)”);
    Console.WriteLine( );
    //
    // Set up some test variables. In actual use this information
    // will come from the payment card itself (debit or credit card).
    //
```

| | |
|---|---|
| var cardtype = “MC”; | // type of card |
| var name = “JOSEPH P DOAKS”; | // cardholder name |
| var cardno = “1234”; | // last 4 digits of card number |
| var expiry = “0701”; | // expiration month and year |

```
    //
    // Concatenate the four components into a single string. In actual use
    there
    // should be code to remove leading/trailing spaces and validate the
    input
    //
    var cat = cardtype + name + cardno + expiry;
    //
    // Convert the string to a byte array
    //
    var bytes = System.Text.Encoding.UTF8.GetBytes(cat);
    //
    // Create the hash
    //
    var hasher = new SHA256Managed( );
    var hash = hasher.ComputeHash(bytes);
    //
    // Print the result to the console as a Base64 string. In practice, the
    // SACI would be used in a data packet to identify the card holder
    //
    var result = Convert.ToBase64String(hash);
    Console.WriteLine(“Card Type: ” + cardtype);
    Console.WriteLine(“Name: ” + name);
    Console.WriteLine(“Card No: XXXX-XXXX-XXXX-” + cardno);
    Console.WriteLine(“Expiry: ” + expiry);
    Console.WriteLine(“Hashresult: ” + result);
}
```

The following example illustrates an implementation of SACI matching using the Microsoft .Net (“dot net”) framework and the C# (“C-Sharp”) programming language. In this example is it presumed that the participating entity has previously generated and stored a SACI for each registered card holder.

```
using System;
using System.Security.Cryptography;
private static void Main( )
{
    Console.WriteLine(″saci - match SACIs)″);
    Console.WriteLine( );
    //
    // Create a local list variable to hold the incoming
    // data transmission records. The details of reading
    // the incoming data stream are not described in this
    // example.
    //
    var incomingRecords = new List<IncomingDataRecord>( );
    incomingRecords = ReadIncomingData( );
    //
    // Get a list of card holders already registered on this system
    // and available through the _db data context
    //
    var cardHolders = new List<CardHolderRecord>( );
    cardHolders = _db.CardHolders.ToList( );
    foreach (var incomingRecord in incomingRecords)
    {
        var cardholder = cardHolders
            .Where(x => x.saci == incomingRecord.saci)
            .FirstOrDefault( );
        if (cardholder != null)
        {
            Console.WriteLine
            ($”saci {incomingRecord.saci} = {cardholder.Name}”);
        }
        Else
        {
            Console.WriteLine
            ($”saci {incomingRecord.saci} not found”);
        }
    }
    }
```

The foregoing description described certain exemplary embodiments. It will be apparent, however, that other variations and modifications or equivalents thereof may be made to the described embodiments, with the attainment of some or all of their advantages. For instance, it is expressly contemplated that instead of the shopper utilizing the coupon card, a mobile application, or other virtual card or payment device may be utilized by the shopper and scanned at POS node (e.g., a register). For example, a virtual card operating on a mobile application on a mobile device may serve as the coupon card. Further, although reference is made to a grocer entity, the CCDP or DIMP may be utilized with any type of store (e.g., department store, online store, etc.) that sells products or services to consumers. Accordingly, the foregoing description is to be taken only by way of example, and not to otherwise limit the scope of the disclosure. It is the object of the appended claims to cover all such variations and modifications as come within the true spirit and scope of the disclosure.

1. A method for conducting a transaction to purchase a product or service, comprising:
scanning a user identification code from a code stored on a card device at a point of sale node using a scanner, wherein the user identification code is associated with each user, and wherein the scanned identification code is associated by the point of sale system to a list of products and coupons scanned and recorded as part of a transaction;
retrieving from the point of sale system to a discount data processing system a record of the transaction, comprising identification of the retail entity, a list of products scanned and associated discount data at the point of sale system as part of the transaction, including the scanned user identification code;
extracting from the data record of the transaction the identification code of the user and using the identification code to reference stored information related to the user;
retrieving a list of available discount incentives for the user at a transaction time; and
determining for which of the available discount incentives the user has met eligibility requirements as stated in a plurality of rules specified with each discount incentive, by matching user purchases in the current transaction against purchase requirements specified in the rules.

2. The method of claim 1 further comprising for which purchase requirements have been met, identifying discount incentives for which eligibility depends upon one or more purchased items and which, if the eligibility requirement prohibit use in combination with other offers, are therefore mutually exclusive.

3. The method of claim 1 further comprising posting to the user's account the total amount of discounts earned, and posting to the discount source accounts the total amount required to pay for the benefits earned by the user and transaction handling fees.

4. The method of claim 1 further comprising a secure data transfer mechanism, in which a first data processing operation resides within the discount data processing system and a second data processing operation resides on a secure data processing platform of a financial card issuing bank, periodically initiating a process whereby the discount data processing system communicates to the issuing bank the identification of users and the accumulated amounts of discount incentives earned by each user; where each user is identified by a source identifier for a secure data transfer mechanism; whereby the financial card issuing bank portion of the system initiates a transfer of cash funds within the issuing bank from the discount source account to the user's financial card account in amounts indicated in the data transferred from the and where the amount transferred is applied to monthly service charges and minimum monthly payments due, with the balance of discount incentive amounts posted as a deposit to a net cash balance of the financial card, with amounts deposited in excess of the total amount owed on the card being reflected as a positive balance of the card user.

5. The method of claim 4 further comprising initiating transfer of funds for a handling fee of a retail location from the discount source account to a retailer's account as specified in data provided by the discount data processing system.

6. The method of claim 4 further comprising initiating transfer of funds to for a processing of the operator from the sponsor deposit account to the operator's account as specified in data provided by the discount data processing system.

7. A transaction method comprising scanning a card device at a point of service node for a product, wherein the card device is associated with at least one stored discount incentive for the product;
determining, by at least one processor of a discount processing system, an amount to credit a user account associated with the card device, wherein the amount credited to the user account is based on a value of the at least one discount incentive;
crediting, by the at least one processor of the platform, a retailer account associated with an entity that sells the product to the user; and
debiting, by the at least one processor of the platform, a discount source account for a discount source of the product, and providing the amount debited from the discount source account to a financial account of the system.

8. The method of claim 7, wherein the amount credited to the retailer account is includes a fee for handling the discount incentive.

9. The method of claim 7, wherein the at least one discount incentive is an electronic discount incentive selected by the user and associated with the card device by the user utilizing one or more web pages associated with the system.

10. The method of claim 7, wherein the user receives the card device from a financial institution, and wherein the card device comprises a credit card or the user also has a credit card from the financial institution.

11. The method of claim 10, wherein the amount credited to the user account further comprises:
applying a portion of the amount to a minimum amount requirement associated with the credit card; and
storing the remainder of the amount in the shopper account that is maintained by a banking institution.

12. The method of claim 7, further comprising:
providing one or more web pages associated with the system to the user, a first authorized user associated with the source, and a second authorized user associated with a manufacturer of the product to create an account with the platform;
selecting, by the user, the first authorized user associated with the entity, and the second authorized user associated with the manufacturer; and
implementing, by the at least one processor of the system, a service selected by the user and selected by the first authorized user, and the second authorized user.

13. The method of claim 12, wherein the service includes at least one of receiving promotions regarding products, receiving advertising services, receiving statistical data regarding sales of products.

14. The method of claim 17, wherein receiving the promotions regarding products further comprises:
receiving a message on a mobile device associated with the user, wherein the message is a promotion for a particular product manufactured by a manufacturer and sold at a selected retail entity.

15. A networked transaction processing apparatus comprising:
one or more network interfaces adapted to communicate data over a computer network;
a processor coupled to the network interfaces and adapted to execute one or more processes; and
a memory configured to store a process executable by the processor, the process when executed operable to:
receive an indication that a user made a purchase for a product at a point of service node associated with a retail entity, wherein the purchase was made by the user utilizing a card having an associated discount incentive, wherein the discount incentive is for the product,
determine an amount to credit a user account associated with the shopper, wherein the amount credited to the user account is based on a value of the discount incentive,
credit a retailer account associated with the retail entity, where the amount credited to the retailer account is based on a fee for handling the discount incentive, and
debit a manufacturer account associated with a manufacturer of the product based on the purchase of the product.

16. The apparatus of claim 15, wherein the discount incentive is an electronic discount incentive chosen by the user and associated with the card.

17. The apparatus of claim 16, wherein the process when executed is further operable to:
maintain one or more web pages utilized to choose the discount incentive that is associated with the card.

18. The apparatus of claim 15, wherein the process, when executed, is further operable to:
apply a portion of the amount credited to the user account, to a minimum payment requirement of a credit card of the user; and
apply a remainder of the amount, credited to the user account, to a financial account associated with the user and maintained by a banking institution.

19. The apparatus of claim 15, wherein the process, when executed, is further operable to:
maintain one or more web pages utilized by the user, a first authorized user associated with the entity, and a second authorized user associated with the manufacturer to establish accounts that allow selected accounts to be credited and debited, wherein
the one or more web pages include a graphical user interface (GUI) such that the user, the retail entity, and the manufacturer can select one or more services.

20. The apparatus of claim 19, wherein the one or more services include at least one of receiving a promotion regarding products, receiving an advertising service, and receiving statistical data regarding sales of products.

21. A networked transaction processing system, comprising:
one or more network interfaces adapted to communicate data over a computer network;
a processor coupled to the network interfaces and adapted to execute one or more processes; and
a memory configured to store a process executable by the processor, the process when executed operable to:
maintain one or more web pages having each web page having at least one graphical user interface (GUI) screen, wherein a manufacturer of a product, a seller of the product, and a user of the product utilize the at least one GUI screen to select one or more services;
wherein the data processor implement the one or more selected services;
credit an account associated with the user and the account associated with the retailer in response to the user purchasing the product utilizing an electronic discount incentive; and
debiting the account associated with the manufacturer in response to the user purchasing the product utilizing an electronic discount incentive.

22. The system of claim 21, wherein the account associated with the user is credited by applying a portion of savings, realized by purchasing the product, to a minimum payment requirement of a credit card utilized by the user.

23. The system of claim 21, wherein a different portion of the saving, realized by purchasing the product, is applied to a financial account of the user maintained by a banking institution.

24. The system of claim 21, wherein an amount credited to the retailer account is based on a fee for handling the discount incentive.

25. The system of claim 21, wherein the services include at least one of receiving promotions regarding products, receiving advertising services, receiving statistical data regarding sales of products.

26. The system of claim 21, wherein the electronic discount incentives are selected by the user utilizing a GUI screen of the one or more web pages.
